(19) United States
(12) Patent Application Publication
(10) Pub. No.: US 2022/0116895 A1
(43) Pub. Date: Apr. 14, 2022

(54) METHOD AND APPARATUS FOR INITIAL ACCESS TECHNIQUE- AND DRX-BASED GENERATION, REPETITION, AND EXTENSION OF V2X SYNCHRONIZATION SIGNAL SEQUENCE

(71) Applicant: LG ELECTRONICS INC., Seoul (KR)

(72) Inventors: Woosuk Ko, Seoul (KR); Seungmin Lee, Seoul (KR)

(21) Appl. No.: 17/431,644

(22) PCT Filed: Mar. 27, 2020
(86) PCT No.: PCT/KR2020/004241

§ 371 Date: Aug. 17, 2021

Related U.S. Application Data
(60) Provisional application No. 62/826,066, filed on Mar. 29, 2019.
(60) Provisional application No. 62/828,469, filed on Apr. 2, 2019.
(60) Provisional application No. 62/829,631, filed on Apr. 4, 2019.

(51) Int. Cl. H04W 56/00; H04L 27/26

(52) U.S. Cl. CPC H04W 56/001; H04W 92/18; H04L 27/2607

(57) ABSTRACT

A method for operating a first device in a wireless communication system is proposed. The method may comprise the steps of: generating a sidelink synchronization signal block (SL SSB); and transmitting the SL SSB to a second device.

### BACKGROUND OF THE DISCLOSURE

### Field of the Disclosure

This disclosure relates to a wireless communication system.

### Related Art

Sidelink (SL) communication is a communication scheme in which a direct link is established between User Equipments (UEs) and the UEs exchange voice and data directly with each other without intervention of an evolved Node B (eNB). SL communication is under consideration as a solution to the overhead of an eNB caused by rapidly increasing data traffic.

Vehicle-to-everything (V2X) refers to a communication technology through which a vehicle exchanges information with another vehicle, a pedestrian, an object having an infrastructure (or infra) established therein, and so on. The V2X may be divided into 4 types, such as vehicle-to-vehicle (V2V), vehicle-to-infrastructure (V2I), vehicle-to-network (V2N), and vehicle-to-pedestrian (V2P). The V2X communication may be provided via a PC5 interface and/or Uu interface.

Meanwhile, as a wider range of communication devices require larger communication capacities, the need for mobile broadband communication that is more enhanced than the existing Radio Access Technology (RAT) is rising. Accordingly, discussions are made on services and user equipment (UE) that are sensitive to reliability and latency. And, a next generation radio access technology that is based on the enhanced mobile broadband communication, massive Machine Type Communication (MTC), Ultra-Reliable and Low Latency Communication (URLLC), and so on, may be referred to as a new radio access technology (RAT) or new radio (NR). Herein, the NR may also support vehicle-to-everything (V2X) communication.

FIG. 1 is a drawing for describing V2X communication based on NR, compared to V2X communication based on RAT used before NR. The embodiment of FIG. 1 may be combined with various embodiments of the present disclosure.

Regarding V2X communication, a scheme of providing a safety service, based on a V2X message such as Basic Safety Message (BSM), Cooperative Awareness Message (CAM), and Decentralized Environmental Notification Message (DENM) is focused in the discussion on the RAT used before the NR. The V2X message may include position information, dynamic information, attribute information, or the like. For example, a UE may transmit a periodic message type CAM and/or an event triggered message type DENM to another UE.

For example, the CAM may include dynamic state information of the vehicle such as direction and speed, static data of the vehicle such as a size, and basic vehicle information such as an exterior illumination state, route details, or the like. For example, the UE may broadcast the CAM, and latency of the CAM may be less than 100 ms. For example, the UE may generate the DENM and transmit it to another UE in an unexpected situation such as a vehicle breakdown, accident, or the like. For example, all vehicles within a transmission range of the UE may receive the CAM and/or the DENM. In this case, the DENM may have a higher priority than the CAM.

Thereafter, regarding V2X communication, various V2X scenarios are proposed in NR. For example, the various V2X scenarios may include vehicle platooning, advanced driving, extended sensors, remote driving, or the like.

For example, based on the vehicle platooning, vehicles may move together by dynamically forming a group. For example, in order to perform platoon operations based on the vehicle platooning, the vehicles belonging to the group may receive periodic data from a leading vehicle. For example, the vehicles belonging to the group may decrease or increase an interval between the vehicles by using the periodic data.

For example, based on the advanced driving, the vehicle may be semi-automated or fully automated. For example, each vehicle may adjust trajectories or maneuvers, based on data obtained from a local sensor of a proximity vehicle and/or a proximity logical entity. In addition, for example, each vehicle may share driving intention with proximity vehicles.

For example, based on the extended sensors, raw data, processed data, or live video data obtained through the local sensors may be exchanged between a vehicle, a logical entity, a UE of pedestrians, and/or a V2X application server. Therefore, for example, the vehicle may recognize a more improved environment than an environment in which a self-sensor is used for detection.

For example, based on the remote driving, for a person who cannot drive or a remote vehicle in a dangerous environment, a remote driver or a V2X application may operate or control the remote vehicle. For example, if a route is predictable such as public transportation, cloud computing based driving may be used for the operation or control of the remote vehicle. In addition, for example, an access for a cloud-based back-end service platform may be considered for the remote driving.

Meanwhile, a scheme of specifying service requirements for various V2X scenarios such as vehicle platooning, advanced driving, extended sensors, remote driving, or the like is discussed in NR-based V2X communication.

### SUMMARY OF THE DISCLOSURE

### Technical Solutions

According to an embodiment, a method of operating a first apparatus 100 in a wireless communication system is proposed. The method comprises: generating a sidelink (SL) SSB; and transmitting the SL SSB to a second apparatus 200.

### Effects of the Disclosure

The user equipment (UE) may efficiently perform SL communication.

### BRIEF DESCRIPTION OF THE DRAWINGS

FIG. 1 is a drawing for describing V2X communication based on NR, compared to V2X communication based on RAT used before NR.

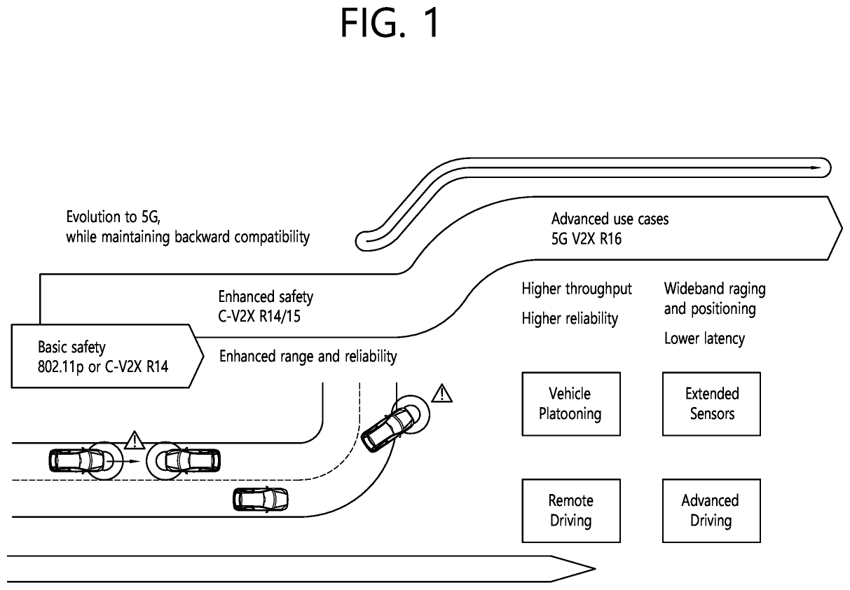

FIG. 2 shows a structure of an NR system, in accordance with an embodiment of the present disclosure.

FIG. 3 shows a functional division between an NG-RAN and a 5GC, in accordance with an embodiment of the present disclosure.

FIG. 4 shows a radio protocol architecture, in accordance with an embodiment of the present disclosure.

FIG. 5 shows a structure of an NR system, in accordance with an embodiment of the present disclosure.

FIG. 6 shows a structure of a slot of an NR frame, in accordance with an embodiment of the present disclosure.

FIG. 7 shows an example of a BWP, in accordance with an embodiment of the present disclosure.

FIG. 8 shows a radio protocol architecture for a SL communication, in accordance with an embodiment of the present disclosure.

FIG. 9 shows a UE performing V2X or SL communication, in accordance with an embodiment of the present disclosure.

FIG. 10 shows a procedure of performing V2X or SL communication by a UE based on a transmission mode, in accordance with an embodiment of the present disclosure.

FIG. 11 shows three cast types, in accordance with an embodiment of the present disclosure.

FIG. 12 shows an SL PSS generated by a first apparatus according to an embodiment of the present disclosure.

FIG. 13 shows an SL PSS generated by a first apparatus according to an embodiment of the present disclosure.

FIG. 14 shows a first SL PSS and a second SL PSS generated by a first apparatus according to an embodiment of the present disclosure.

FIG. 15 shows a first SL PSS and a second SL PSS generated by a first apparatus according to an embodiment of the present disclosure.

FIG. 16 shows a first SL PSS and a second SL PSS generated by a first apparatus according to an embodiment of the present disclosure.

FIG. 17 shows a procedure in which a first apparatus generates an SL PSS, according to an embodiment of the present disclosure.

FIG. 18 shows a procedure in which a first apparatus generates an SL SSS, according to an embodiment of the present disclosure.

FIG. 19 shows a procedure in which a first apparatus generates an SL SSS, according to an embodiment of the present disclosure.

FIG. 20 shows a procedure in which a first apparatus transmits an SL SSB, according to an embodiment of the present disclosure.

FIG. 21 shows a procedure in which a second apparatus receives an SL SSB, according to an embodiment of the present disclosure.

FIG. 22 shows a communication system 1, in accordance with an embodiment of the present disclosure.

FIG. 23 shows wireless devices, in accordance with an embodiment of the present disclosure.

FIG. 24 shows a signal process circuit for a transmission signal, in accordance with an embodiment of the present disclosure.

FIG. 25 shows another example of a wireless device, in accordance with an embodiment of the present disclosure.

FIG. 26 shows a hand-held device, in accordance with an embodiment of the present disclosure.

FIG. 27 shows a vehicle or an autonomous vehicle, in accordance with an embodiment of the present disclosure.

### DESCRIPTION OF EXEMPLARY EMBODIMENTS

In the present specification, “A or B” may mean “only A”, “only B” or “both A and B.” In other words, in the present specification, “A or B” may be interpreted as “A and/or B”. For example, in the present specification, “A, B, or C” may mean “only A”, “only B”, “only C”, or “any combination of A, B, C”.

A slash (/) or comma used in the present specification may mean “and/or”. For example, “A/B” may mean “A and/or B”. Accordingly, “A/B” may mean “only A”, “only B”, or “both A and B”. For example, “A, B, C” may mean “A, B, or C”.

In the present specification, “at least one of A and B” may mean “only A”, “only B”, or “both A and B”. In addition, in the present specification, the expression “at least one of A or B” or “at least one of A and/or B” may be interpreted as “at least one of A and B”.

In addition, in the present specification, “at least one of A, B, and C” may mean “only A”, “only B”, “only C”, or “any combination of A, B, and C”. In addition, “at least one of A, B, or C” or “at least one of A, B, and/or C” may mean “at least one of A, B, and C”.

In addition, a parenthesis used in the present specification may mean “for example”. Specifically, when indicated as “control information (PDCCH)”, it may mean that “PDCCH” is proposed as an example of the “control information”. In other words, the “control information” of the present specification is not limited to “PDCCH”, and “PDDCH” may be proposed as an example of the “control information”. In addition, when indicated as “control information (i.e., PDCCH)”, it may also mean that “PDCCH” is proposed as an example of the “control information”.

A technical feature described individually in one figure in the present specification may be individually implemented, or may be simultaneously implemented.

The technology described below may be used in various wireless communication systems such as code division multiple access (CDMA), frequency division multiple access (FDMA), time division multiple access (TDMA), orthogonal frequency division multiple access (OFDMA), single carrier frequency division multiple access (SC-FDMA), and so on. The CDMA may be implemented with a radio technology, such as universal terrestrial radio access (UTRA) or CDMA-2000. The TDMA may be implemented with a radio technology, such as global system for mobile communications (GSM)/general packet ratio service (GPRS)/enhanced data rate for GSM evolution (EDGE). The OFDMA may be implemented with a radio technology, such as institute of electrical and electronics engineers (IEEE) 802.11 (Wi-Fi), IEEE 802.16 (WiMAX), IEEE 802.20, evolved UTRA (E-UTRA), and so on. IEEE 802.16m is an evolved version of IEEE 802.16e and provides backward compatibility with a system based on the IEEE 802.16e. The UTRA is part of a universal mobile telecommunication system (UMTS). 3rd generation partnership project (3GPP) long term evolution (LTE) is part of an evolved UMTS (E-UMTS) using the E-UTRA. The 3GPP LTE uses the OFDMA in a downlink and uses the SC-FDMA in an uplink. LTE-advanced (LTE-A) is an evolution of the LTE.

5G NR is a successive technology of LTE-A corresponding to a new Clean-slate type mobile communication system having the characteristics of high performance, low latency, high availability, and so on. 5G NR may use resources of all spectrum available for usage including low frequency bands of less than 1 GHz, middle frequency bands ranging from 1 GHz to 10 GHz, high frequency (millimeter waves) of 24 GHz or more, and so on.

For clarity in the description, the following description will mostly focus on LTE-A or 5G NR. However, technical features according to an embodiment of the present disclosure will not be limited only to this.

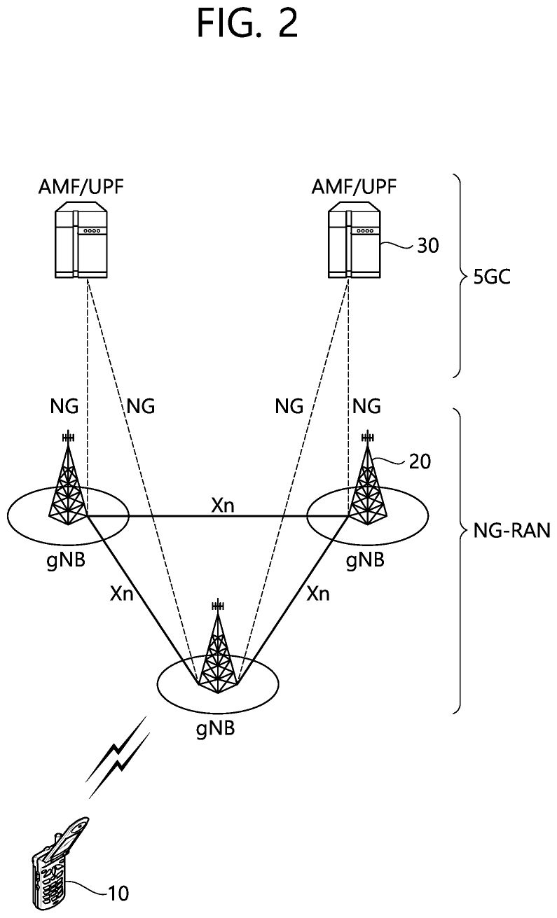

FIG. 2 shows a structure of an NR system, in accordance with an embodiment of the present disclosure. The embodiment of FIG. 2 may be combined with various embodiments of the present disclosure.

Referring to FIG. 2, a next generation-radio access network (NG-RAN) may include a BS 20 providing a UE 10 with a user plane and control plane protocol termination. For example, the BS 20 may include a next generation-Node B (gNB) and/or an evolved-NodeB (eNB). For example, the UE 10 may be fixed or mobile and may be referred to as other terms, such as a mobile station (MS), a user terminal (UT), a subscriber station (SS), a mobile terminal (MT), wireless device, and so on. For example, the BS may be referred to as a fixed station which communicates with the UE 10 and may be referred to as other terms, such as a base transceiver system (BTS), an access point (AP), and so on.

The embodiment of FIG. 2 exemplifies a case where only the gNB is included. The BSs 20 may be connected to one another via Xn interface. The BS 20 may be connected to one another via 5th generation (5G) core network (5GC) and NG interface. More specifically, the BSs 20 may be connected to an access and mobility management function (AMF) 30 via NG C interface, and may be connected to a user plane function (UPF) 30 via NG-U interface.

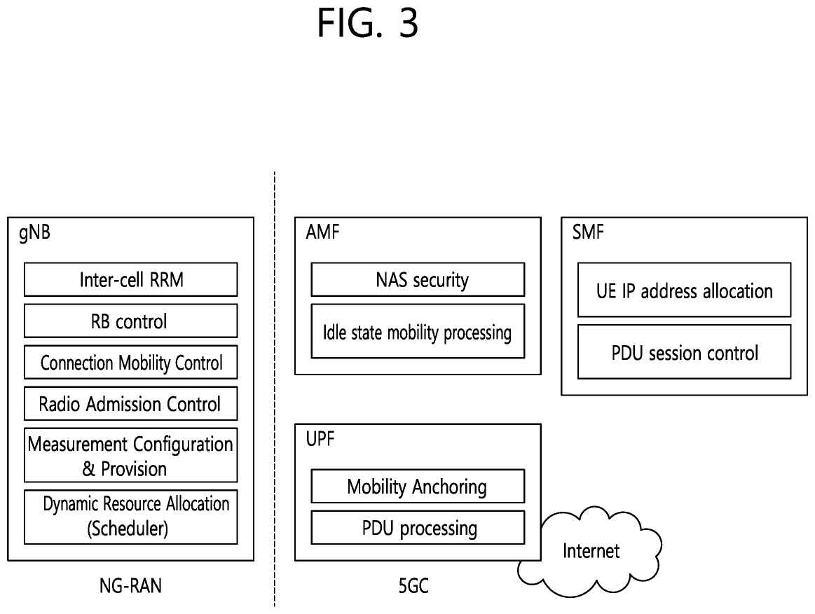

FIG. 3 shows a functional division between an NG-RAN and a 5GC, in accordance with an embodiment of the present disclosure. The embodiment of FIG. 3 may be combined with various embodiments of the present disclosure.

Referring to FIG. 3, the gNB may provide functions, such as Inter Cell Radio Resource Management (RRM), Radio Bearer (RB) control, Connection Mobility Control, Radio Admission Control, Measurement Configuration & Provision, Dynamic Resource Allocation, and so on. An AMF may provide functions, such as Non Access Stratum (NAS) security, idle state mobility processing, and so on. A UPF may provide functions, such as Mobility Anchoring, Protocol Data Unit (PDU) processing, and so on. A Session Management Function (SMF) may provide functions, such as user equipment (UE) Internet Protocol (IP) address allocation, PDU session control, and so on.

Layers of a radio interface protocol between the UE and the network can be classified into a first layer (L1), a second layer (L2), and a third layer (L3) based on the lower three layers of the open system interconnection (OSI) model that is well-known in the communication system. Among them, a physical (PHY) layer belonging to the first layer provides an information transfer service by using a physical channel, and a radio resource control (RRC) layer belonging to the third layer serves to control a radio resource between the UE and the network. For this, the RRC layer exchanges an RRC message between the UE and the BS.

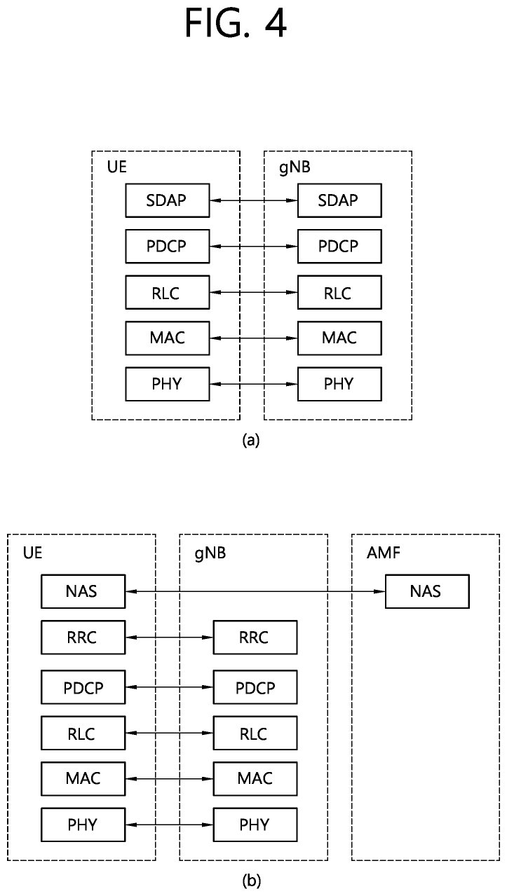

FIG. 4 shows a radio protocol architecture, in accordance with an embodiment of the present disclosure. The embodiment of FIG. 4 may be combined with various embodiments of the present disclosure. Specifically, FIG. 4(a) shows a radio protocol architecture for a user plane, and FIG. 4(b) shows a radio protocol architecture for a control plane. The user plane corresponds to a protocol stack for user data transmission, and the control plane corresponds to a protocol stack for control signal transmission.

Referring to FIG. 4, a physical layer provides an upper layer with an information transfer service through a physical channel. The physical layer is connected to a medium access control (MAC) layer which is an upper layer of the physical layer through a transport channel. Data is transferred between the MAC layer and the physical layer through the transport channel. The transport channel is classified according to how and with what characteristics data is transmitted through a radio interface.

Between different physical layers, i.e., a physical layer of a transmitter and a physical layer of a receiver, data are transferred through the physical channel. The physical channel is modulated using an orthogonal frequency division multiplexing (OFDM) scheme, and utilizes time and frequency as a radio resource.

The MAC layer provides services to a radio link control (RLC) layer, which is a higher layer of the MAC layer, via a logical channel. The MAC layer provides a function of mapping multiple logical channels to multiple transport channels. The MAC layer also provides a function of logical channel multiplexing by mapping multiple logical channels to a single transport channel. The MAC layer provides data transfer services over logical channels.

The RLC layer performs concatenation, segmentation, and reassembly of Radio Link Control Service Data Unit (RLC SDU). In order to ensure diverse quality of service (QoS) required by a radio bearer (RB), the RLC layer provides three types of operation modes, i.e., a transparent mode (TM), an unacknowledged mode (UM), and an acknowledged mode (AM). An AM RLC provides error correction through an automatic repeat request (ARQ).

A radio resource control (RRC) layer is defined only in the control plane. The RRC layer serves to control the logical channel, the transport channel, and the physical channel in association with configuration, reconfiguration and release of RBs. The RB is a logical path provided by the first layer (i.e., the physical layer or the PHY layer) and the second layer (i.e., the MAC layer, the RLC layer, and the packet data convergence protocol (PDCP) layer) for data delivery between the UE and the network.

Functions of a packet data convergence protocol (PDCP) layer in the user plane include user data delivery, header compression, and ciphering. Functions of a PDCP layer in the control plane include control-plane data delivery and ciphering/integrity protection.

A service data adaptation protocol (SDAP) layer is defined only in a user plane. The SDAP layer performs mapping between a Quality of Service (QoS) flow and a data radio bearer (DRB) and QoS flow ID (QFI) marking in both DL and UL packets.

The configuration of the RB implies a process for specifying a radio protocol layer and channel properties to provide a particular service and for determining respective detailed parameters and operations. The RB can be classified into two types, i.e., a signaling RB (SRB) and a data RB (DRB). The SRB is used as a path for transmitting an RRC message in the control plane. The DRB is used as a path for transmitting user data in the user plane.

When an RRC connection is established between an RRC layer of the UE and an RRC layer of the E-UTRAN, the UE is in an RRC_CONNECTED state, and, otherwise, the UE may be in an RRC_IDLE state. In case of the NR, an RRC_INACTIVE state is additionally defined, and a UE being in the RRC_INACTIVE state may maintain its connection with a core network whereas its connection with the BS is released.

Data is transmitted from the network to the UE through a downlink transport channel. Examples of the downlink transport channel include a broadcast channel (BCH) for transmitting system information and a downlink-shared channel (SCH) for transmitting user traffic or control messages. Traffic of downlink multicast or broadcast services or the control messages can be transmitted on the downlink-SCH or an additional downlink multicast channel (MCH). Data is transmitted from the UE to the network through an uplink transport channel. Examples of the uplink transport channel include a random access channel (RACH) for transmitting an initial control message and an uplink SCH for transmitting user traffic or control messages.

Examples of logical channels belonging to a higher channel of the transport channel and mapped onto the transport channels include a broadcast channel (BCCH), a paging control channel (PCCH), a common control channel (CCCH), a multicast control channel (MCCH), a multicast traffic channel (MTCH), etc.

The physical channel includes several OFDM symbols in a time domain and several sub-carriers in a frequency domain. One sub-frame includes a plurality of OFDM symbols in the time domain. A resource block is a unit of resource allocation, and consists of a plurality of OFDM symbols and a plurality of sub-carriers. Further, each subframe may use specific sub-carriers of specific OFDM symbols (e.g., a first OFDM symbol) of a corresponding subframe for a physical downlink control channel (PDCCH), i.e., an L1/L2 control channel. A transmission time interval (TTI) is a unit time of subframe transmission.

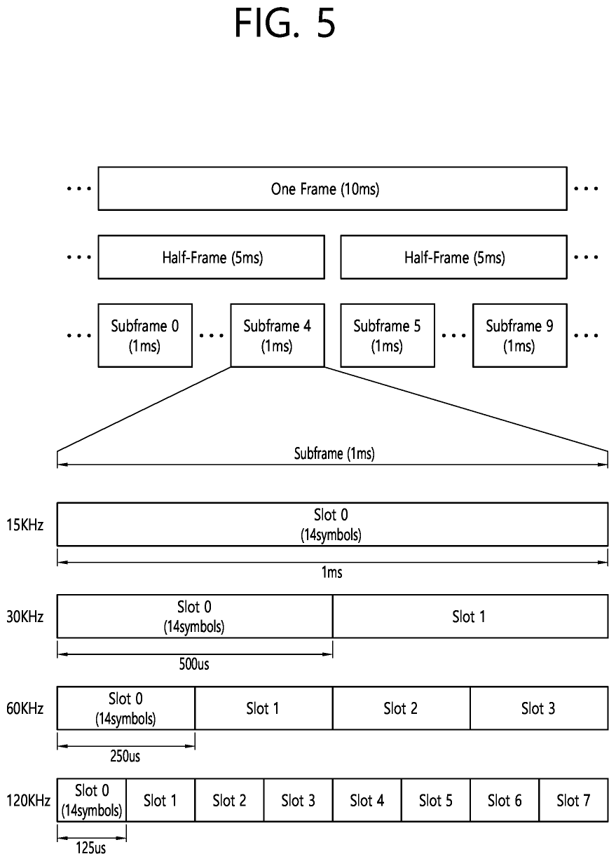

FIG. 5 shows a structure of an NR system, in accordance with an embodiment of the present disclosure. The embodiment of FIG. 5 may be combined with various embodiments of the present disclosure.

Referring to FIG. 5, in the NR, a radio frame may be used for performing uplink and downlink transmission. A radio frame has a length of 10 ms and may be defined to be configured of two half-frames (HFs). A half-frame may include five 1 ms subframes (SFs). A subframe (SF) may be divided into one or more slots, and the number of slots within a subframe may be determined in accordance with subcarrier spacing (SCS). Each slot may include 12 or 14 OFDM(A) symbols according to a cyclic prefix (CP).

In case of using a normal CP, each slot may include 14 symbols. In case of using an extended CP, each slot may include 12 symbols. Herein, a symbol may include an OFDM symbol (or CP-OFDM symbol) and a Single Carrier-FDMA (SC-FDMA) symbol (or Discrete Fourier Transform-spread-OFDM (DFT-s-OFDM) symbol).

Table 1 shown below represents an example of a number of symbols per slot (N^{slot}_{symb}), a number slots per frame (N^{frame,u}ₛₗₒₜ), and a number of slots per subframe (N^{subframe}ₛₗₒₜ) in accordance with an SCS configuration (u), in a case where a normal CP is used.

TABLE 1

| SCS (15*2^{u}) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

Table 2 shows an example of a number of symbols per slot, a number of slots per frame, and a number of slots per subframe in accordance with the SCS, in a case where an extended CP is used.

TABLE 2

| SCS (15*2^{u}) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In an NR system, OFDM(A) numerologies (e.g., SCS, CP length, and so on) between multiple cells being integrate to one UE may be differently configured. Accordingly, a (absolute time) duration (or section) of a time resource (e.g., subframe, slot or TTI) (collectively referred to as a time unit (TU) for simplicity) being configured of the same number of symbols may be differently configured in the integrated cells. In the NR, multiple numerologies or SCSs for supporting diverse 5G services may be supported. For example, in case an SCS is 15 kHz, a wide area of the conventional cellular bands may be supported, and, in case an SCS is 30 kHz/60 kHz a dense-urban, lower latency, wider carrier bandwidth may be supported. In case the SCS is 60 kHz or higher, a bandwidth that is greater than 24.25 GHz may be used in order to overcome phase noise.

An NR frequency band may be defined as two different types of frequency ranges. The two different types of frequency ranges may be FR1 and FR2. The values of the frequency ranges may be changed (or varied), and, for example, the two different types of frequency ranges may be as shown below in Table 3. Among the frequency ranges that are used in an NR system, FR1 may mean a “sub 6 GHz range”, and FR2 may mean an “above 6 GHz range” and may also be referred to as a millimeter wave (mmW).

TABLE 3

| Frequency Range | Corresponding | |
|---|---|---|
| designation | frequency range | Subcarrier Spacing (SCS) |
| FR1 | 450 MHz-6000 MHz | 15, 30, 60 kHz |
| FR2 | 24250 MHz-52600 MHz | 60, 120, 240 kHz |

As described above, the values of the frequency ranges in the NR system may be changed (or varied). For example, as shown below in Table 4, FR1 may include a band within a range of 410 MHz to 7125 MHz. More specifically, FR1 may include a frequency band of 6 GHz (or 5850, 5900, 5925 MHz, and so on) and higher. For example, a frequency band of 6 GHz (or 5850, 5900, 5925 MHz, and so on) and higher being included in FR1 mat include an unlicensed band. The unlicensed band may be used for diverse purposes, e.g., the unlicensed band for vehicle-specific communication (e.g., automated driving).

TABLE 4

| Frequency Range | Corresponding | |
|---|---|---|
| designation | frequency range | Subcarrier Spacing (SCS) |
| FR1 | 410 MHz-7125 MHz | 15, 30, 60 kHz |
| FR2 | 24250 MHz-52600 MHz | 60, 120, 240 kHz |

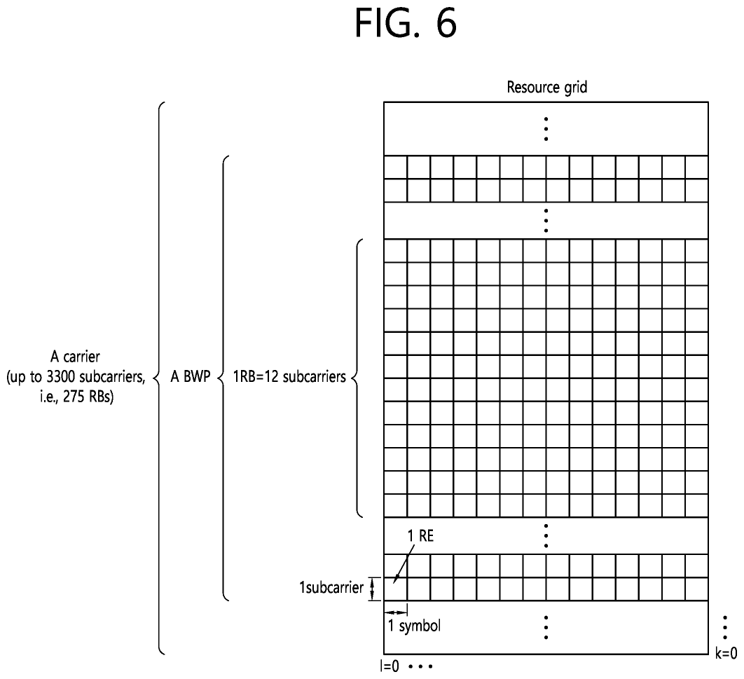

FIG. 6 shows a structure of a slot of an NR frame, in accordance with an embodiment of the present disclosure. The embodiment of FIG. 6 may be combined with various embodiments of the present disclosure. Referring to FIG. 6, a slot includes a plurality of symbols in a time domain. For example, in case of a normal CP, one slot may include 14 symbols. However, in case of an extended CP, one slot may include 12 symbols. Alternatively, in case of a normal CP, one slot may include 7 symbols. However, in case of an extended CP, one slot may include 6 symbols.

A carrier includes a plurality of subcarriers in a frequency domain. A Resource Block (RB) may be defined as a plurality of consecutive subcarriers (e.g., 12 subcarriers) in the frequency domain. A Bandwidth Part (BWP) may be defined as a plurality of consecutive (Physical) Resource Blocks ((P)RBs) in the frequency domain, and the BWP may correspond to one numerology (e.g., SCS, CP length, and so on). A carrier may include a maximum of N number BWPs (e.g., 5 BWPs). Data communication may be performed via an activated BWP. Each element may be referred to as a Resource Element (RE) within a resource grid and one complex symbol may be mapped to each element.

Meanwhile, a radio interface between a UE and another UE or a radio interface between the UE and a network may consist of an L1 layer, an L2 layer, and an L3 layer. In various embodiments of the present disclosure, the L1 layer may imply a physical layer. In addition, for example, the L2 layer may imply at least one of a MAC layer, an RLC layer, a PDCP layer, and an SDAP layer. In addition, for example, the L3 layer may imply an RRC layer.

Hereinafter, a bandwidth part (BWP) and a carrier will be described.

The BWP may be a set of consecutive physical resource blocks (PRBs) in a given numerology. The PRB may be selected from consecutive sub-sets of common resource blocks (CRBs) for the given numerology on a given carrier.

When using bandwidth adaptation (BA), a reception bandwidth and transmission bandwidth of a UE are not necessarily as large as a bandwidth of a cell, and the reception bandwidth and transmission bandwidth of the BS may be adjusted. For example, a network/BS may inform the UE of bandwidth adjustment. For example, the UE receive information/configuration for bandwidth adjustment from the network/BS. In this case, the UE may perform bandwidth adjustment based on the received information/configuration. For example, the bandwidth adjustment may include an increase/decrease of the bandwidth, a position change of the bandwidth, or a change in subcarrier spacing of the bandwidth.

For example, the bandwidth may be decreased during a period in which activity is low to save power. For example, the position of the bandwidth may move in a frequency domain. For example, the position of the bandwidth may move in the frequency domain to increase scheduling flexibility. For example, the subcarrier spacing of the bandwidth may be changed. For example, the subcarrier spacing of the bandwidth may be changed to allow a different service. A subset of a total cell bandwidth of a cell may be called a bandwidth part (BWP). The BA may be performed when the BS/network configures the BWP to the UE and the BS/network informs the UE of the BWP currently in an active state among the configured BWPs.

For example, the BWP may be at least any one of an active BWP, an initial BWP, and/or a default BWP. For example, the UE may not monitor downlink radio link quality in a DL BWP other than an active DL BWP on a primary cell (PCell). For example, the UE may not receive PDCCH, PDSCH, or CSI-RS (excluding RRM) outside the active DL BWP. For example, the UE may not trigger a channel state information (CSI) report for the inactive DL BWP. For example, the UE may not transmit PUCCH or PUSCH outside an active UL BWP. For example, in a downlink case, the initial BWP may be given as a consecutive RB set for an RMSI CORESET (configured by PBCH). For example, in an uplink case, the initial BWP may be given by SIB for a random access procedure. For example, the default BWP may be configured by a higher layer. For example, an initial value of the default BWP may be an initial DL BWP. For energy saving, if the UE fails to detect DCI during a specific period, the UE may switch the active BWP of the UE to the default BWP.

Meanwhile, the BWP may be defined for SL. The same SL BWP may be used in transmission and reception. For example, a transmitting UE may transmit an SL channel or an SL signal on a specific BWP, and a receiving UE may receive the SL channel or the SL signal on the specific BWP. In a licensed carrier, the SL BWP may be defined separately from a Uu BWP, and the SL BWP may have configuration signaling separate from the Uu BWP. For example, the UE may receive a configuration for the SL BWP from the BS/network. The SL BWP may be (pre-)configured in a carrier with respect to an out-of-coverage NR V2X UE and an RRC_IDLE UE. For the UE in the RRC_CONNECTED mode, at least one SL BWP may be activated in the carrier.

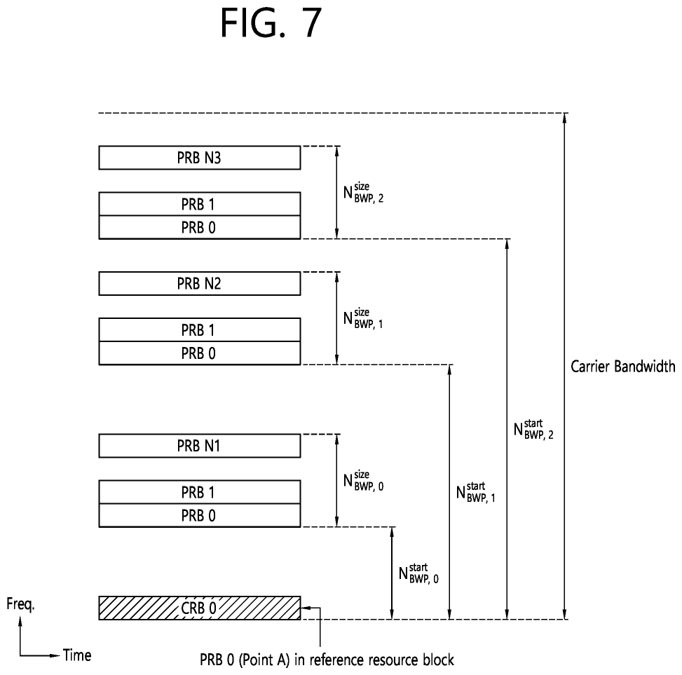

FIG. 7 shows an example of a BWP, in accordance with an embodiment of the present disclosure. The embodiment of FIG. 7 may be combined with various embodiments of the present disclosure. It is assumed in the embodiment of FIG. 7 that the number of BWPs is 3.

Referring to FIG. 7, a common resource block (CRB) may be a carrier resource block numbered from one end of a carrier band to the other end thereof. In addition, the PRB may be a resource block numbered within each BWP. A point A may indicate a common reference point for a resource block grid.

The BWP may be configured by a point A, an offset N^{start}_{BWP} from the point A, and a bandwidth N^{size}_{BWP}. For example, the point A may be an external reference point of a PRB of a carrier in which a subcarrier 0 of all numerologies (e.g., all numerologies supported by a network on that carrier) is aligned. For example, the offset may be a PRB interval between a lowest subcarrier and the point A in a given numerology. For example, the bandwidth may be the number of PRBs in the given numerology.

Hereinafter, V2X or SL communication will be described.

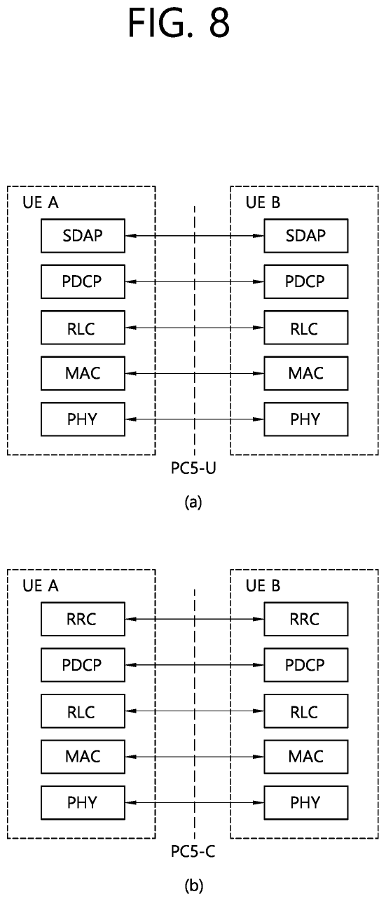

FIG. 8 shows a radio protocol architecture for a SL communication, in accordance with an embodiment of the present disclosure. The embodiment of FIG. 8 may be combined with various embodiments of the present disclosure. More specifically, FIG. 8(a) shows a user plane protocol stack, and FIG. 8(b) shows a control plane protocol stack.

Hereinafter, a sidelink synchronization signal (SLSS) and synchronization information will be described.

The SLSS may include a primary sidelink synchronization signal (PSSS) and a secondary sidelink synchronization signal (SSSS), as an SL-specific sequence. The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and for synchronization acquisition. For example, the UE may use the S-PSS and the S-SSS for acquisition of detailed synchronization and for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit CRC.

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier.

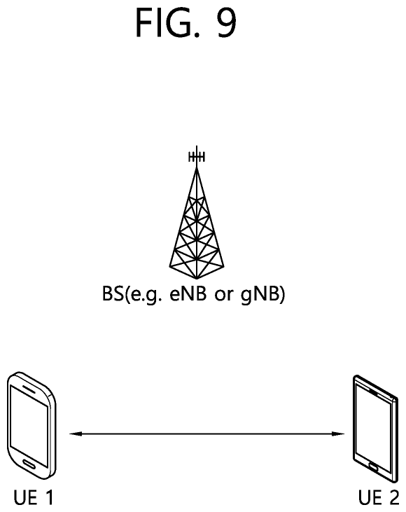

FIG. 9 shows a UE performing V2X or SL communication, in accordance with an embodiment of the present disclosure. The embodiment of FIG. 9 may be combined with various embodiments of the present disclosure.

Referring to FIG. 9, in V2X or SL communication, the term ‘UE’ may generally imply a UE of a user. However, if a network equipment such as a BS transmits/receives a signal according to a communication scheme between UEs, the BS may also be regarded as a sort of the UE. For example, a UE 1 may be a first apparatus 100, and a UE 2 may be a second apparatus 200.

For example, the UE 1 may select a resource unit corresponding to a specific resource in a resource pool which implies a set of series of resources. In addition, the UE 1 may transmit an SL signal by using the resource unit. For example, a resource pool in which the UE 1 is capable of transmitting a signal may be configured to the UE 2 which is a receiving UE, and the signal of the UE 1 may be detected in the resource pool.

Herein, if the UE 1 is within a connectivity range of the BS, the BS may inform the UE 1 of the resource pool. Otherwise, if the UE 1 is out of the connectivity range of the BS, another UE may inform the UE 1 of the resource pool, or the UE 1 may use a pre-configured resource pool.

In general, the resource pool may be configured in unit of a plurality of resources, and each UE may select a unit of one or a plurality of resources to use it in SL signal transmission thereof.

Hereinafter, resource allocation in SL will be described.

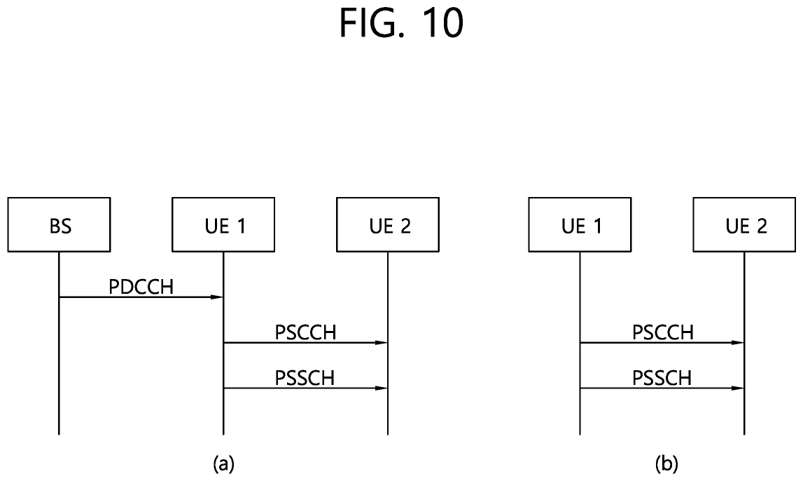

FIG. 10 shows a procedure of performing V2X or SL communication by a UE based on a transmission mode, in accordance with an embodiment of the present disclosure. The embodiment of FIG. 10 may be combined with various embodiments of the present disclosure. In various embodiments of the present disclosure, the transmission mode may be called a mode or a resource allocation mode. Hereinafter, for convenience of explanation, in LTE, the transmission mode may be called an LTE transmission mode. In NR, the transmission mode may be called an NR resource allocation mode.

For example, FIG. 10(a) shows a UE operation related to an LTE transmission mode 1 or an LTE transmission mode 3. Alternatively, for example, FIG. 10(a) shows a UE operation related to an NR resource allocation mode 1. For example, the LTE transmission mode 1 may be applied to general SL communication, and the LTE transmission mode 3 may be applied to V2X communication.

For example, FIG. 10(b) shows a UE operation related to an LTE transmission mode 2 or an LTE transmission mode 4. Alternatively, for example, FIG. 10(b) shows a UE operation related to an NR resource allocation mode 2.

Referring to FIG. 10(a), in the LTE transmission mode 1, the LTE transmission mode 3, or the NR resource allocation mode 1, a BS may schedule an SL resource to be used by the UE for SL transmission. For example, the BS may perform resource scheduling to a UE 1 through a PDCCH (more specifically, downlink control information (DCI)), and the UE 1 may perform V2X or SL communication with respect to a UE 2 according to the resource scheduling. For example, the UE 1 may transmit a sidelink control information (SCI) to the UE 2 through a physical sidelink control channel (PSCCH), and thereafter transmit data based on the SCI to the UE 2 through a physical sidelink shared channel (PSSCH).

Referring to FIG. 10(b), in the LTE transmission mode 2, the LTE transmission mode 4, or the NR resource allocation mode 2, the UE may determine an SL transmission resource within an SL resource configured by a BS/network or a pre-configured SL resource. For example, the configured SL resource or the pre-configured SL resource may be a resource pool. For example, the UE may autonomously select or schedule a resource for SL transmission. For example, the UE may perform SL communication by autonomously selecting a resource within a configured resource pool. For example, the UE may autonomously select a resource within a selective window by performing a sensing and resource (re)selection procedure. For example, the sensing may be performed in unit of subchannels. In addition, the UE 1 which has autonomously selected the resource within the resource pool may transmit the SCI to the UE 2 through a PSCCH, and thereafter may transmit data based on the SCI to the UE 2 through a PSSCH.

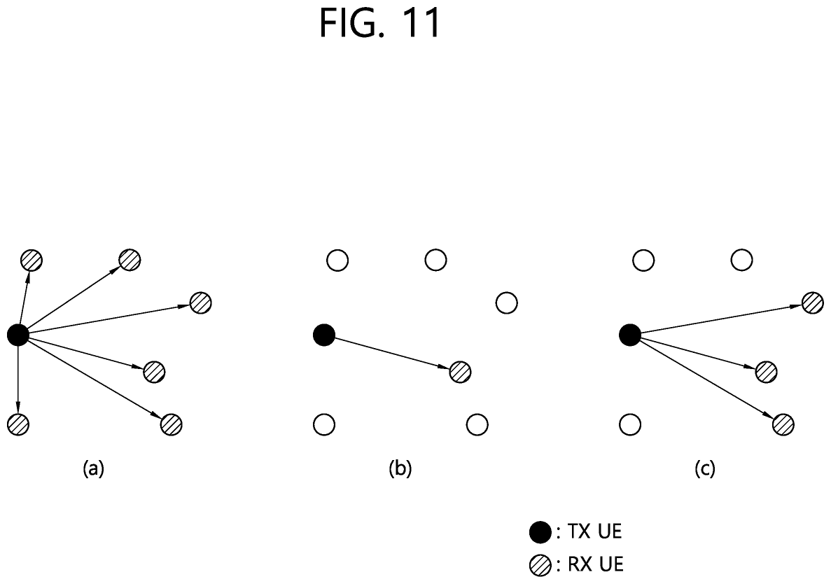

FIG. 11 shows three cast types, in accordance with an embodiment of the present disclosure. The embodiment of FIG. 11 may be combined with various embodiments of the present disclosure. Specifically, FIG. 11(a) shows broadcast-type SL communication, FIG. 11(b) shows unicast type-SL communication, and FIG. 11(c) shows groupcast-type SL communication. In case of the unicast-type SL communication, a UE may perform one-to-one communication with respect to another UE. In case of the groupcast-type SL transmission, the UE may perform SL communication with respect to one or more UEs in a group to which the UE belongs. In various embodiments of the present disclosure, SL groupcast communication may be replaced with SL multicast communication, SL one-to-many communication, or the like.

Meanwhile, in the next-generation communication system, various use cases may be supported. For example, a service for communication such as an autonomous vehicle, a smart car, or a connected car may be considered. For this service, each vehicle can send and receive information as a communication user equipment (UE), select a resource for communication with or without a base station's help depending on the situation, and send and receive messages between UEs.

Hereinafter, a sidelink synchronization signal (SLSS) and synchronization information will be described.

The SLSS may be an SL-specific sequence and include a primary sidelink synchronization signal (PSSS) and a secondary sidelink synchronization signal (SSSS). The PSSS may be referred to as a sidelink primary synchronization signal (S-PSS), and the SSSS may be referred to as a sidelink secondary synchronization signal (S-SSS). For example, length-127 M-sequences may be used for the S-PSS, and length-127 gold sequences may be used for the S-SSS. For example, a UE may use the S-PSS for initial signal detection and/or for synchronization acquisition. For example, the UE may use the S-PSS and the S-SSS for acquisition of fine synchronization and/or for detection of a synchronization signal ID.

A physical sidelink broadcast channel (PSBCH) may be a (broadcast) channel for transmitting default (system) information which must be first known by the UE before SL signal transmission/reception. For example, the default information may be information related to SLSS, a duplex mode (DM), a time division duplex (TDD) uplink/downlink (UL/DL) configuration, information related to a resource pool, a type of an application related to the SLSS, a subframe offset, broadcast information, or the like. For example, for evaluation of PSBCH performance, in NR V2X, a payload size of the PSBCH may be 56 bits including 24-bit CRC.

The S-PSS, the S-SSS, and the PSBCH may be included in a block format (e.g., SL synchronization signal (SS)/PSBCH block, hereinafter, sidelink-synchronization signal block (S-SSB)) supporting periodical transmission. The S-SSB may have the same numerology (i.e., SCS and CP length) as a physical sidelink control channel (PSCCH)/physical sidelink shared channel (PSSCH) in a carrier, and a transmission bandwidth may exist within a (pre-)configured sidelink (SL) BWP. For example, the S-SSB may have a bandwidth of 11 resource blocks (RBs). For example, the PSBCH may exist across 11 RBs. In addition, a frequency position of the S-SSB may be (pre-)configured. Accordingly, the UE does not have to perform hypothesis detection at frequency to discover the S-SSB in the carrier. For example, the SL PSS may mean the S-PSS. Similarly, SL SSS may mean the S-SSS. For example, SL SBB may mean the S-SSB.

According to an embodiment of the present disclosure, an SL SSB on a V2X communication system may be configured with SL PSS, SL SSS and SL-PBCH. For example, a UE may detect an initial signal using the SL PSS and may obtain synchronization. For example, the UE may acquire detailed synchronization using the SL PSS and the SL SSS, and may detect a synchronization signal ID. For example, a PSBCH may be a (broadcast) channel through which basic (system) information that a UE needs to know first before SL transmission and reception is transmitted. Accordingly, each of constituent signals constituting the SL SSB may be a very important signal in order to obtain synchronization and basic system information. For example, in order for a UE to perform normal data communication, the UE may need to perform a process of receiving and decoding an SL SSB signal before performing sidelink communication.

According to an embodiment of the present disclosure, in order to efficiently perform sidelink communication, a first apparatus may design an SL SSB signal to maximize reception and decoding performance. For example, the first apparatus may design an SL PSS signal and/or an SL SSS signal so that sequences used for the SL PSS have high cross-correlation with each other. For example, a first apparatus may design an SL PSS signal and/or an SL SSS signal so that sequences used for the SL SSS have high cross-correlation with each other. For example, a first apparatus may design an SL PSS signal and/or an SL SSS signal so that the SL PSS signals and the SL SSS signals have low correlation with each other. For example, a first apparatus may design an SL PSS signal and/or an SL SSS signal so that the SL PSS signals and the SL SSS signals can be detected relatively easily even if the frequency offset is low.

According to an embodiment of the present disclosure, an SL PSS may include a plurality of sequences. For example, the sequence may be a sequence using a part of a synchronization signal ID. Through the sequence, information related to whether a UE exists within an area in which a signal transmitted by a base station can be received may be transmitted. Accordingly, the SL PSS may have to have a high auto-correlation characteristic and a low cross-correlation characteristic.

For example, an SL SSS may include a plurality of sequences. For example, synchronization signal ID information and the like may be transmitted through the sequence. Therefore, the SL SSS may have to have high autocorrelation characteristics and low cross-correlation characteristics.

For example, when a UE detects a signal for the first time, and synchronizes, the frequency offset may be in a non-corrected state. Therefore, an SL PSS that can be used for initial synchronization may have to have robust detection performance against frequency offset. That is, for example, an SL PSS may have a capability of being relatively easily detected even if the frequency offset is low.

According to an embodiment of the present disclosure, an SL PSS may include N1 sequences. For example, each of the N1 sequences may be generated using the same polynomial. For example, each of the N1 sequences may be generated from an m-sequence having one length L value. In this case, in order for the SL PSS to have the most robust detection performance in relation to frequency offset, each of the N1 sequences may be generated by using an m-sequence having the one length L value and a cyclic shift that is an integer multiple of L/N1. Or, for example, in order for the SL PSS to have the most robust detection performance with respect to frequency offset, each of the N1 sequences may be generated by using an m-sequence having one length L value and a cyclic shift with a value that is integer multiplied by the nearest integer of L/N1.

According to an embodiment of the present disclosure, an SL SSS may include a greater number of SL SSS sequences than SL PSS sequences having a length of L. The SL SSS may have a low correlation with the SL PSS. For example, the SL SSS may be generated by performing an exclusive-OR (XOR) operation on two different m-sequences. For example, the SL SSS may be a gold sequence. For example, the polynomial used to generate the SL PSS may be used to generate the first sequence among the two different m-sequences. In this case, the SL PSS and the SL SSS may have a low correlation with each other. For example, the second sequence among the two different m-sequences may be generated based on a sequence different from that of the SL PSS.

For example, a first UE may use SL PSS and SL SSS for Uu connection (link) between a base station and the UE. In this case, for example, if the SL PSS and the SL SSS used for SL communication between the first UE and a second UE have a high correlation with the Uu connection, the synchronization performance of the SL communication may be deteriorated. Alternatively, for example, if the SL PSS and the SL SSS have low cross-correlation with the Uu connection, there may be a problem in that the SL communication is greatly affected by frequency offset.

According to an embodiment of the present disclosure, Uu communication between a base station and a first UE and the SL communication between the first UE and a second UE may operate in a Time-Division Duplex (TDD) scheme. For example, the first UE may use SL PSS and SL SSS having low cross-correlation with a synchronization signal used in Uu communication. For example, the SL PSS and the SL SSS may be robust to a frequency offset upon initial access. That is, for example, the SL PSS and the SL SSS may have a capability of being relatively easily detected even if the frequency offset is low. For example, SL PSS and SL SSS may have to satisfy conditions described below in order to satisfy the above capabilities.

For example, SL PSS may have high autocorrelation. That is, the SL PSS may have high correlation with a signal based on the same sequence as itself. For example, SL PSS may have low cross-correlation. That is, the SL PSS may have low correlation with a signal based on a sequence different from that of the SL PSS. For example, a first SL PSS may have low cross-correlation with a second SL PSS generated based on a second cyclic shift different from a first cyclic shift used to generate the first SL PSS.

For example, SL SSS may have high autocorrelation. That is, the SL SSS may have high correlation with a signal based on the same sequence as itself. For example, SL SSS may have low cross-correlation. That is, the SL SSS may have a low correlation with a signal based on a sequence different from that of the SL SSS. For example, a first SL SSS may have low cross-correlation with a second SL SSS generated based on a second cyclic shift different from the first cyclic shift used to generate the first SL SSS.

For example, SL PSS and SL SSS may have low cross-correlation with each other. For example, a UE receiving the SL PSS and the SL SSS can easily distinguish the SL PSS from the SL SSS.

For example, SL PSS and SL SSS may be robust to frequency offset. That is, for example, the SL PSS and the SL SSS may have a capability of being relatively easily detected even if the frequency offset is low.

For example, a synchronization signal used for SL communication and a synchronization signal used for Uu communication may have low cross-correlation with each other. For example, the synchronization signal used for the SL communication may include an SL PSS and/or an SL SSS. For example, the synchronization signal used for the Uu communication may include a Uu PSS and/or a Uu SSS. For example, a UE receiving a synchronization signal used for SL communication and a synchronization signal used for Uu communication can easily distinguish the synchronization signal used for the SL communication and the synchronization signal used for the Uu communication.

According to an embodiment of the present disclosure, an SL PSS may be generated using a polynomial related to generation of a Uu PSS. For example, the SL PSS may be generated based on a second cyclic shift having a maximum difference from a first cyclic shift related to the generation of the Uu PSS.

For example, an SL SSS may be generated using a polynomial related to generation of a Uu SSS. For example, the SL SSS may be generated based on a second cyclic shift different from a first cyclic shift associated with the generation of the Uu SSS. The SL SSS may be generated based on a second initial value different from a first initial value related to the generation of the Uu SSS. For example, a UE may perform coherent detection through the SL SSS only after an initial synchronization process through a PSS. Therefore, the robustness related to the frequency offset of a SSS may be required to be relatively weaker than the robustness related to the frequency offset of a PSS. That is, if a UE that has undergone the initial synchronization process through a PSS can overcome residual offset through a SSS, it can be considered that the SSS satisfies the required condition.

According to an embodiment of the present disclosure, Uu PSS used for NR Uu communication uses an m-sequence having a length of 127. For example, the Uu PSS may include three Uu PSS sequences. The three Uu PSS sequences can be generated using cyclic shifts of 0, 43 and 86. For example, the 0, 43, and 86 may be values obtained by multiplying 43 by an integer. Here, a frequency offset at which detection ambiguity does not occur may be a value obtained by dividing a cyclic shift by two. For example, when Uu PSS is detected, a frequency offset at which detection ambiguity does not occur may include 21.5 subcarrier spacing. That is, Uu PSS can be detected without ambiguity for frequency offsets lower than 21.5 subcarrier spacing.

According to an embodiment of the present disclosure, a Uu SSS used for NR Uu communication may be generated by performing an exclusive-OR (XOR) operation on two m-sequences. The sequence generated by performing the exclusive OR operation may be a gold sequence. For example, the two m-sequences may be a first m-sequence and a second m-sequence. For example, the first m-sequence may be generated using a first polynomial related to generation of a Uu PSS. The second m-sequence may be generated using a second polynomial different from the first polynomial. For example, since the Uu SSS is generated using the first polynomial related to the generation of the Uu PSS, cross-correlation between the Uu PSS and the Uu SSS may be increased.

According to an embodiment of the present disclosure, SL communication may be performed in Uu communication and TDD method. For example, an SL PSS used for the SL communication may be generated such that a cross correlation between the SL PSS and the Uu communication is low. For example, the SL PSS may be generated using a polynomial related to generation of a Uu PSS. For example, the SL PSS may be generated using a second cyclic shift different from the first cyclic shift associated with the generation of the Uu PSS. Here, the second cyclic shift may be set so that sequences related to the SL PSS have an equal difference from each other. Also, for example, the SL PSS may be generated based on the second cyclic shift having a maximum difference from the first cyclic shift related to the generation of the Uu PSS.

According to an embodiment of the present disclosure, an SL PSS used for NR SL communication may include three sequences. For example, a first cyclic shift value associated with generation of the three sequences may be obtained by adding an integer close to 43/2 to a value multiplied by an integer of 43. As described above, the first cyclic shift value obtained by adding an integer close to 43/2 to a value multiplied by an integer of 43 may have the largest difference from a second cyclic shift related to the generation of a Uu PSS. In addition, the three sequences generated based on the first cyclic shift may have the largest cyclic shift difference from each other. For example, when a first cyclic shift value is obtained by adding an integer close to 43/2 to a value multiplied by an integer of 43, and a sequence related to an SL PSS is generated based on the first cyclic shift value, when a UE performs initial access using the sequence related to the SL PSS, detection ambiguity related to the Uu PSS may not occur. For example, a frequency offset value that can be overcome when performing initial access using the sequence related to the SL PSS is half of the frequency offset value that can be overcome when a UE performs initial access using the Uu PSS. For example, a frequency offset value that can be overcome when performing initial access using a sequence related to the SL PSS may be 21 and/or 22.

According to an embodiment of the present disclosure, a UE may detect an SL PSS at a time. That is, the UE may perform one-shot detection. For example, a UE may perform one-shot detection using a plurality of sequences related to SL PSS. In order for the UE to perform one-shot detection using the plurality of sequences related to the SL PSS, the number of different cyclic shift values may be increased. For example, a cyclic shift value may increase in proportion to the number of the plurality of sequences related to the SL PSS. For example, as the number of different cyclic shift values increases, a frequency offset value to be overcome during initial connection may decrease. For example, if the frequency offset value to be overcome during initial connection is reduced, the detection performance of the synchronization signal may be deteriorated. Accordingly, a method of generating a sequence different from the m-sequence included in the Uu PSS may be used to generate the SL PSS. For example, a second cyclic shift different from a first cyclic shift associated with generation of the m-sequence included in the Uu PSS may be used to generate the SL PSS. For example, when the SL PSS is generated using the second cyclic shift, a frequency offset value that can be overcome when the UE performs initial access using the SL PSS may increase. For example, when a first sequence included in the SL PSS is generated using the second cyclic shift, cross-correlation between the first sequence included in the SL PSS and the Uu PSS may be reduced. For example, when a first sequence included in the SL PSS is generated using the second cyclic shift, the cross-correlation between the first sequence included in the SL PSS and a second sequence, which is different from the first sequence included in the SL PSS, may be deteriorated. For example, when a first sequence included in the SL PSS is generated using the second cyclic shift, cross-correlation between the first sequence included in the SL PSS and the Uu SSS may be reduced. For example, when a first sequence included in the SL PSS is generated using the second cyclic shift, cross-correlation related to the first sequence included in the SL PSS and the SL SSS may be deteriorated.

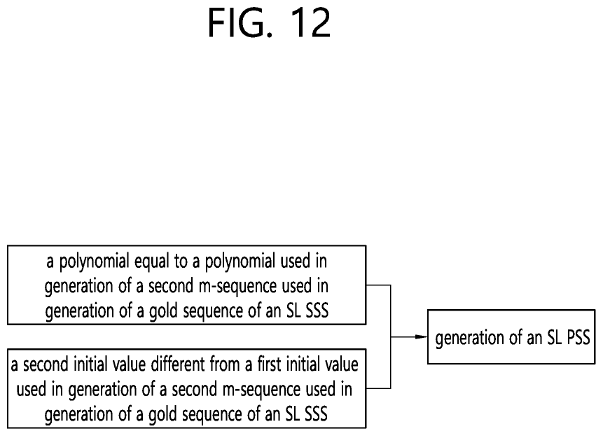

FIG. 12 shows an SL PSS generated by a first apparatus according to an embodiment of the present disclosure. The embodiment of FIG. 12 may be combined with various embodiments of the present disclosure.

Referring to FIG. 12, an SL PSS may include a plurality of sequences. For example, an SL SSS may be generated by a method of generating a gold sequence. The SL SSS may be generated by performing a mutual exclusive OR operation on a first m-sequence and a second m-sequence. For example, the plurality of sequences included in the SL PSS may be generated using a polynomial used to generate the second m-sequence. For example, the plurality of sequences included in the SL PSS may be generated using a second initial value different from a first initial value used to generate the second m-sequence. For example, the plurality of sequences included in the SL PSS may each mean an SL PSS.

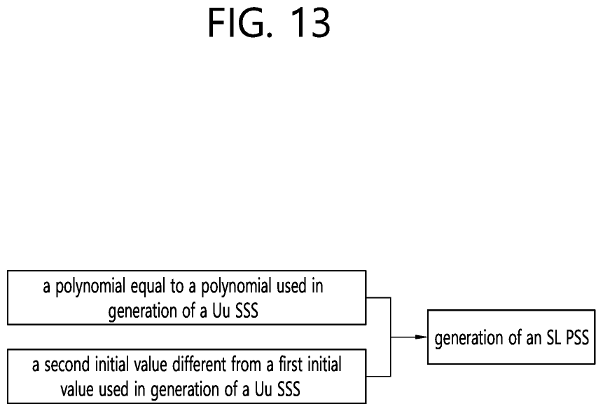

FIG. 13 shows an SL PSS generated by a first apparatus according to an embodiment of the present disclosure. The embodiment of FIG. 13 may be combined with various embodiments of the present disclosure.

Referring to FIG. 13, an SL PSS may include a plurality of sequences. For example, the plurality of sequences included in the SL PSS may be generated using a polynomial used to generate a Uu SSS. For example, the plurality of sequences included in the SL PSS may be generated using a second initial value different from a first initial value used to generate the Uu SSS. For example, the plurality of sequences included in the SL PSS may each mean an SL PSS.

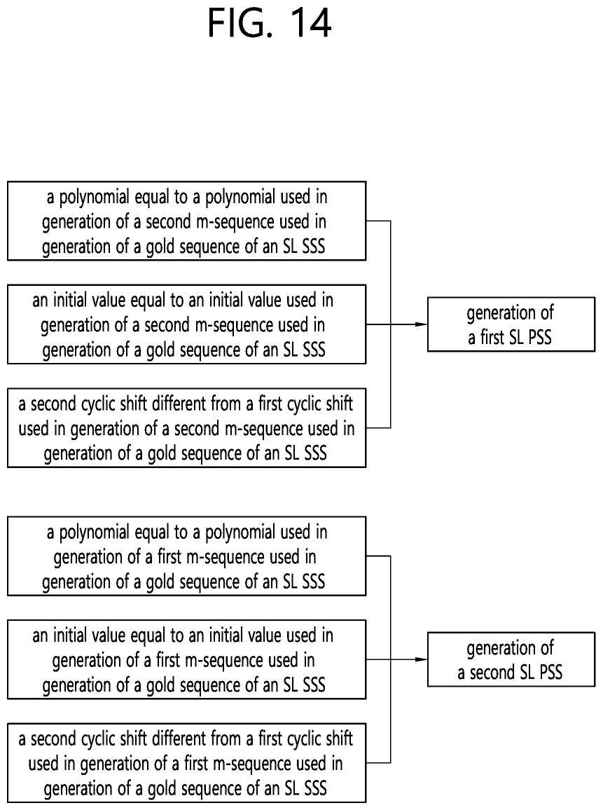

FIG. 14 shows a first SL PSS and a second SL PSS generated by a first apparatus according to an embodiment of the present disclosure. The embodiment of FIG. 14 may be combined with various embodiments of the present disclosure.

Referring to FIG. 14, an SL PSS may include two sequences. For example, the two sequences may include a first SL PSS and/or a second SL PSS. For example, the SL SSS may be generated by a method of generating a gold sequence. The SL SSS may be generated by performing a mutual exclusive OR operation on a first m-sequence and a second m-sequence. For example, the first SL PSS may be generated using a polynomial used to generate the second m-sequence. For example, the first SL PSS may be generated using an initial value used to generate the second m-sequence. For example, the first SL PSS may be generated using a second cyclic shift different from a first cyclic shift used to generate the second m-sequence. For example, the second SL PSS may be generated using a polynomial used to generate the first m-sequence. For example, the second SL PSS may be generated using an initial value used to generate the first m-sequence. For example, the second SL PSS may be generated using a fourth cyclic shift different from the third cyclic shift used to generate the first m-sequence.

For example, the cross-correlation between the first SL PSS and the second SL PSS may be maintained low. Also, for example, since the first SL PSS and the second SL PSS are generated using a polynomial used for generation of a SL SSS, the cross-correlation between a Uu synchronization signal and a SL synchronization signal may be maintained low. For example, since the second SL PSS is generated using a polynomial used to generate the SL SSS, the cross-correlation between the SL PSS and the SL SSS may be maintained low.

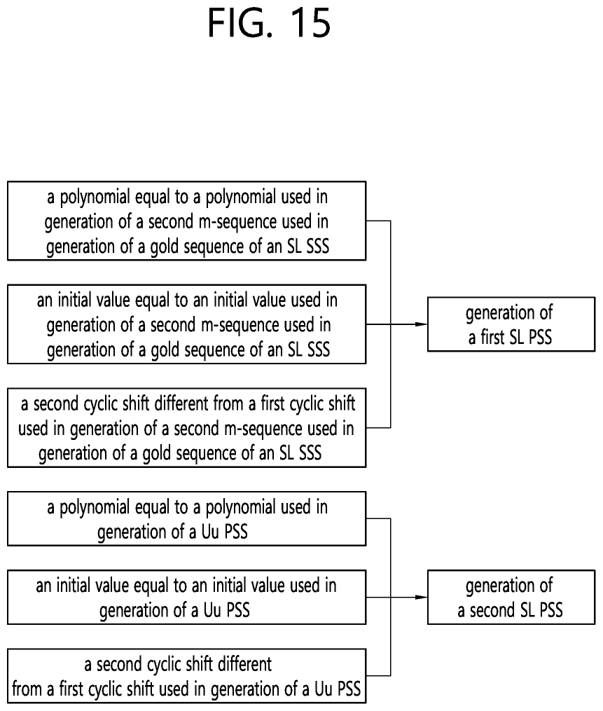

FIG. 15 shows a first SL PSS and a second SL PSS generated by a first apparatus according to an embodiment of the present disclosure. The embodiment of FIG. 15 may be combined with various embodiments of the present disclosure.

Referring to FIG. 15, an SL PSS may include two sequences. For example, the two sequences may include a first SL PSS and/or a second SL PSS. For example, an SL SSS may be generated by a method of generating a gold sequence. The SL SSS may be generated by performing a mutual exclusive OR operation on a first m-sequence and a second m-sequence. For example, the first SL PSS may be generated using a polynomial used to generate the second m-sequence. For example, the first SL PSS may be generated using an initial value used to generate the second m-sequence. For example, the first SL PSS may be generated using a second cyclic shift different from a first cyclic shift used to generate the second m-sequence. For example, the second SL PSS may be generated using a polynomial used to generate a Uu PSS. For example, the second SL PSS may be generated using an initial value used to generate the Uu PSS. For example, the second SL PSS may be generated using a second cyclic shift different from a first cyclic shift used to generate the Uu PSS.

For example, the cross-correlation between the first SL PSS and the second SL PSS may be maintained low. Also, for example, since the first SL PSS and the second SL PSS are generated using a polynomial used to generate the Uu PSS, the cross-correlation between a Uu synchronization signal and a SL synchronization signal may be maintained low. For example, since the first SL PSS and the second SL PSS are generated using the polynomial used to generate the Uu PSS, the cross-correlation between the SL PSS and the SL SSS may be maintained low. Also, for example, since the second SL PSS is generated using the polynomial used for generation of the Uu PSS, the maximum value of a frequency offset value that can be overcome when the UE performs initial access using the SL PSS can be obtained irrespective of the number of sequences included in the Uu PSS.

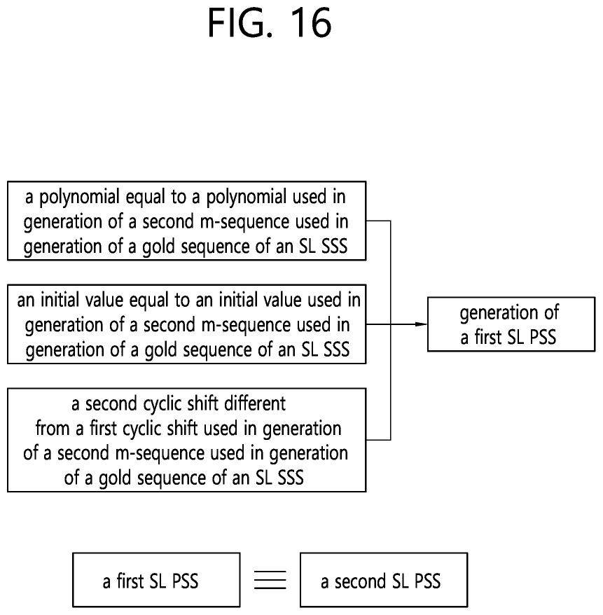

FIG. 16 shows a first SL PSS and a second SL PSS generated by a first apparatus according to an embodiment of the present disclosure. The embodiment of FIG. 16 may be combined with various embodiments of the present disclosure.

Referring to FIG. 16, an SL PSS may include two sequences. For example, the two sequences may include a first SL PSS and/or a second SL PSS. For example, an SL SSS may be generated by a method of generating a gold sequence. The SL SSS may be generated by performing a mutual exclusive OR operation on a first m-sequence and a second m-sequence. For example, the first SL PSS may be generated using a polynomial used to generate the second m-sequence. For example, the first SL PSS may be generated using an initial value used to generate the second m-sequence. For example, the first SL PSS may be generated using a second cyclic shift different from a first cyclic shift used to generate the second m-sequence. For example, the second SL PSS may include the same sequence as the first SL PSS. For example, since the SL PSS is generated by a method different from that of a Uu PSS, the cross-correlation between the SL PSS and the Uu PSS may be maintained low. For example, since the SL PSS is generated using a polynomial related to the generation of the SL SSS, the cross-correlation between the SL PSS and the SL SSS may be maintained low. For example, since the SL PSS is generated in a different way from that of the Uu PSS, the maximum value of a frequency offset value that can be overcome when the UE performs initial access using the SL PSS may be obtained irrespective of the number of the sequences included in the Uu PSS.

According to an embodiment of the present disclosure, an SL PSS may include two sequences. For example, the two sequences may include a first SL PSS and/or a second SL PSS. For example, the first SL PSS may be generated using a polynomial used to generate a Uu SSS. For example, the first SL PSS may be generated using an initial value used to generate the Uu SSS. For example, the first SL PSS may be generated using a second cyclic shift different from a first cyclic shift used to generate the Uu SSS. For example, the second SL PSS may include the same sequence as the first SL PSS. For example, since the SL PSS is generated by a method different from that of the Uu PSS, the cross-correlation between the SL PSS and the Uu PSS may be maintained low. For example, since the SL PSS is generated using a polynomial related to the generation of the SL SSS, the cross-correlation between the SL PSS and the SL SSS may be maintained low. For example, since the SL PSS is generated in a different way from that of the Uu PSS, the maximum value of a frequency offset value that can be overcome when the UE performs initial access using the SL PSS may be obtained irrespective of the number of the sequences included in the Uu PSS.

According to an embodiment of the present disclosure, the number of symbols related to an SL PSS and an SL SSS included in an SL SSB and the number of repetitions may be determined so that the coverage related to SL communication may be determined to be provided at the same level as the coverage provided by downlink (DL) PSS and/or DL SSS. The coverage may mean an area in which signal reception is possible. For example, the coverage provided by the DL PSS and/or the DL SSS may be provided based on a Maximum Power Reduction (MPR) value between the DL PSS and the DL SSS and an MPR value between the SL PSS and the SL SSS. For example, a Maximum Power Reduction (MPR) value between the DL PSS and the DL SSS may be assigned according to a Peak-to-Average Power Ratio (PAPR) between the DL PSS and the DL SSS and a cubic metric characteristic.

For example, a DL PSS may include a Zadoff-chu sequence. For example, the Zadoff-chu sequence may have low PAPR characteristics. For example, a DL PSS may include two repeated symbols. The symbol may include the DL PSS. For example, PAPR characteristic of an SL PSS may have a higher value than a PAPR characteristic of a Zadoff-chu sequence. Thus, for example, in order for a coverage related to SL communication to be provided at the same level as coverage provided by DL PSS and/or DL SSS, the SL PSS may include three symbols. Alternatively, the same symbol may be repeatedly included in an SL PSS three times. Or, for example, in order for coverage related to SL communication to be provided at the same level as coverage provided by a DL PSS and/or a DL SSS, SL PSS may include 4 symbols. Alternatively, the same symbol may be repeatedly included in the SL PSS four times.

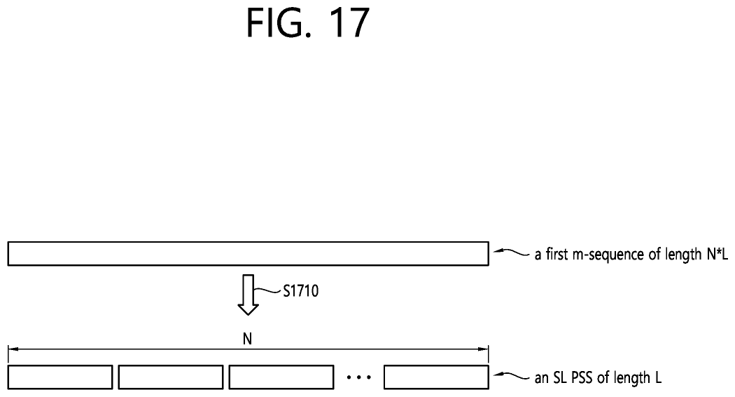

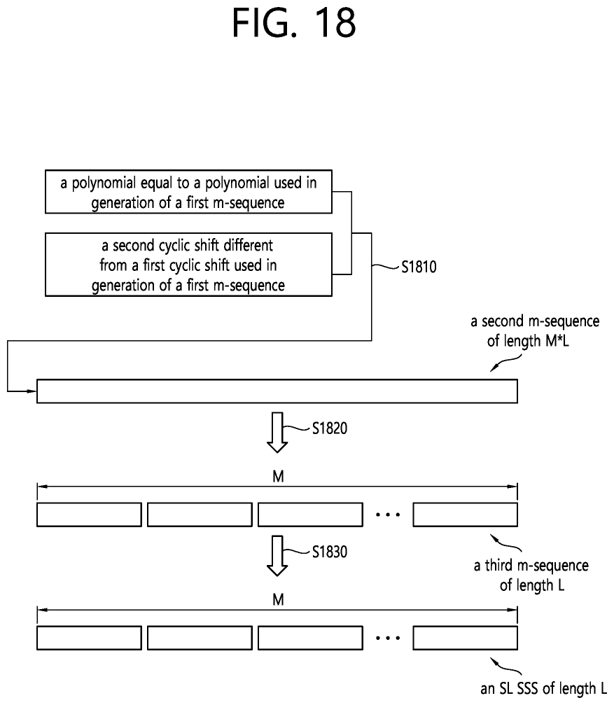

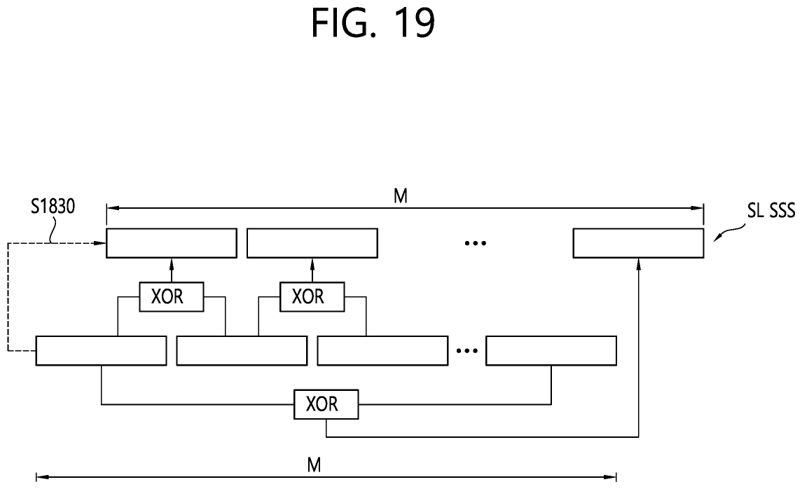

FIG. 17 shows a procedure in which a first device generates an SL PSS by a first apparatus, according to an embodiment of the present disclosure. FIG. 18 shows a procedure in which a first apparatus generates an SL SSS, according to an embodiment of the present disclosure. FIG. 19 shows a procedure in which a first apparatus generates an SL SSS, according to an embodiment of the present disclosure. 17 to 19 may be combined with various embodiments of the present disclosure.

Referring to FIG. 17, a UE may generate a first m-sequence having a length of N*L. In step S1710, the UE may generate N SL PSSs having a length of L by dividing the first m-sequence. For example, the SL PSS may be an m-sequence.

For example, the UE may transmit by including all of the N SL PSSs in an SL SSB. The receiving end may receive all of the N SL PSSs. For example, when the receiving end detects the SL PSS, the N SL PSSs may be detected in. When the receiving end detects the N SL PSSs in concatenation, the detection performance of the receiving end may be higher than when the receiving end detects a plurality of SL PSSs generated in an independent manner.

Referring to FIG. 18, in step S1810, a UE may generate a second m-sequence having a length of M*L. For example, the second m-sequence may be generated using a polynomial used to generate the first m-sequence. For example, the second m-sequence may be generated using a second cyclic shift that is different from the first cyclic shift used to generate the first m-sequence. In step S1820, the UE may generate M third m-sequences having a length of L by dividing the second m-sequence. In step S1830, the UE may sequentially perform an exclusive-OR operation on the M third m-sequences to generate M SL SSSs having a length of L. For example, the exclusive OR operation may be sequentially performed by selecting two arbitrary sequences from among the M third m-sequences. For example, the cross-correlation between the SL SSS and the SL PSS generated through the procedure of FIG. 18 may be maintained low. For example, the detection performance of the SL SSS generated through the procedure of FIG. 18 may be high.

For example, N and M may be an integer of 2 or more. For example, when the N and M are different, the UE may generate the second m-sequence by using the initial value used to generate the first m-sequence. For example, when the N and M are the same, the UE may generate the second m-sequence by using a second initial value different from the first initial value used to generate the first m-sequence.

FIG. 19 shows the procedure of step S1830. Referring to FIG. 19, the UE may perform an exclusive OR operation on two third m-sequences. Then, another exclusive-OR operation is performed on one of the sequences used in the prior exclusive-OR operation and a third m-sequence not used in the prior exclusive-OR operation. By repeating the above procedure for all the third m-sequences, the UE can generate M SL SSSs. For example, the last exclusive-OR operation may be performed on the two third m-sequences used for the prior exclusive-OR operation only once among the M third m-sequences. For example, a pair of a third m-sequence on which an exclusive-OR operation is performed may be sequentially formed in an order of division from the second m-sequence. For example, the exclusive-OR operation may be sequentially performed on the third m-sequence pairs formed in the divided order. Alternatively, for example, the third m-sequence pair may be arbitrarily formed. For example, the exclusive-OR operation may be sequentially performed on the arbitrarily formed third m-sequence pair.

According to an embodiment of the present disclosure, Uu communication and SL communication may be simultaneously performed in a TTD scheme. For example, according to an embodiment of the present disclosure, a UE may generate an SL PSS and/or an SL SSS. For example, when the SL PSS and the SL SSS are generated according to an embodiment of the present disclosure, the cross-correlation between the SL PSS and the SL SSS may be minimized In addition, when the SL PSS is used for initial access, the UE can detect the synchronization signal without detection ambiguity. For example, a frequency offset value that can be overcome when the UE performs initial access using the SL PSS may be allowed to a maximum. For example, the SL PSS and/or the SL SSS may be generated based on a polynomial used to generate a Uu PSS and/or a Uu SSS used for Uu communication. For example, the synchronization performance of the SL communication using the SL PSS and/or the SL SSS may be the same as the synchronization performance of the Uu communication.

According to an embodiment of the present disclosure, a first UE may generate an SL PSS and/or an SL SSS based on a sequence related to a Uu PSS and/or a Uu SSS. For example, the first UE may generate the SL PSS and/or the SL SSS based on an initial value and/or the cyclic shift used to generate the sequence related to the Uu PSS and/or the Uu SSS. For example, the first UE may generate an SL PSS and/or an SL SSS based on repetition and/or division of a sequence. Also, for example, the first UE may transmit the SL PSS and/or the SL SSS to a second UE. The first UE may broadcast the SL PSS and/or the SL SSS. For specific details, refer to the description of the relevant part above.

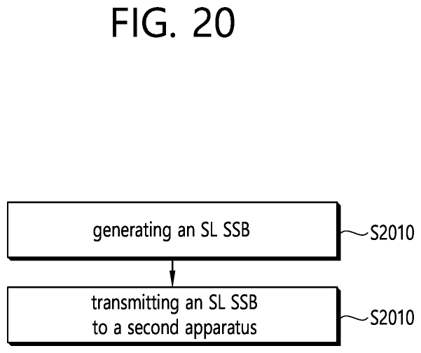

FIG. 20 shows a procedure in which a first apparatus transmits an SL SSB, according to an embodiment of the present disclosure. The embodiment of FIG. 20 may be combined with various embodiments of the present disclosure.

Referring to FIG. 20, in step S2010, a first apparatus may generate a sidelink (SL) synchronization signal block (SSB). In step S2020, the first apparatus may transmit the SL SSB to a second apparatus. For example, the SL SSB may include a first SL primary synchronization signal (PSS), a second SL PSS, a first SL secondary synchronization signal (SSS), and a second SL SSS. For example, the first SL SSS may be generated based on a first m-sequence and a second m-sequence. For example, the first SL PSS may be generated based on a second polynomial different from a first polynomial related to generation of a Uu PSS and a second cyclic shift different from a first cyclic shift related to the generation of the Uu PSS.

For example, the first SL PSS may be generated based on a polynomial and an initial value related to generation of the second m-sequence. For example, the first SL PSS may be generated based on a polynomial equal to a polynomial related to generation of the second m-sequence and a second initial value different from a first initial value related to the generation of the second m-sequence.

For example, the first SL PSS may be generated based on a polynomial, an initial value, and a cyclic shift related to generation of the second m-sequence. For example, the first SL PSS may be generated based on a polynomial equal to the polynomial related to the generation of the second m-sequence, an initial value equal to the initial value related to the generation of the second m-sequence, and a fourth cyclic shift different from a third cyclic shift related to the generation of the second m-sequence. For example, the second SL PSS may be generated based on a polynomial, an initial value, and a cyclic shift related to generation of the first m-sequence. For example, the second SL PSS may be generated based on a polynomial equal to the polynomial related to the generation of the first m-sequence, an initial value equal to the initial value related to the generation of the first m-sequence, and a sixth cyclic shift different from a fifth cyclic shift related to the generation of the first m-sequence.

Alternatively, for example, the second SL PSS may be generated based on a polynomial, an initial value, and a cyclic shift related to generation of a Uu PSS. For example, the second SL PSS may be generated based on a polynomial equal to the polynomial related to the generation of the Uu PSS, an initial value equal to the initial value related to the generation of the Uu PSS, and a fifth cyclic shift different from the first cyclic shift related to the generation of the Uu PSS.

For example, the second SL PSS may be equal to the first SL PSS.

For example, the first SL PSS may be generated based on a polynomial and an initial value related to generation of a Uu SSS. For example, the first SL PSS may be generated based on a polynomial equal to the polynomial related to the generation of the Uu SSS and a second initial value different from a first initial value related to the generation of the Uu SSS.

The above-described embodiment may be applied to various apparatuses to be described below. For example, a processor 102 of a first apparatus 100 may generate a sidelink (SL) synchronization signal block (SSB). In addition, the processor 102 of the first apparatus 100 may control the transceiver 106 to transmit the SL SSB to a second apparatus 200.

According to an embodiment of the present disclosure, a first apparatus for performing wireless communication may be proposed. For example, the first apparatus may comprise one or more memories storing instructions; one or more transceivers; and one or more processors connected to the one or more memories and the one or more transceivers. For example, the one or more processors may execute the instructions to: generate a sidelink (SL) synchronization signal block (SSB); and transmit the SL SSB to a second apparatus. For example, the SL SSB may include a first SL primary synchronization signal (PSS), a second SL PSS, a first SL secondary synchronization signal (SSS), and a second SL SSS, wherein the first SL SSS may be generated based on a first m-sequence and a second m-sequence, wherein the first SL PSS is generated based on a second polynomial different from a first polynomial related to generation of a Uu PSS and a second cyclic shift different from a first cyclic shift related to the generation of the Uu PSS.

According to an embodiment of the present disclosure, an apparatus configured to control a first user equipment (UE) may be proposed. For example, the apparatus may comprise one or more processors; and one or more memories operably connectable to the one or more processors and storing instructions. For example, the one or more processors may execute the instructions to: generate a sidelink (SL) synchronization signal block (SSB); and transmit the SL SSB to a second UE. For example, the SL SSB may include a first SL primary synchronization signal (PSS), a second SL PSS, a first SL secondary synchronization signal (SSS), and a second SL SSS, wherein the first SL SSS is generated based on a first m-sequence and a second m-sequence, and wherein the first SL PSS is generated based on a second polynomial different from a first polynomial related to generation of a Uu PSS and a second cyclic shift different from a first cyclic shift related to the generation of the Uu PSS.

According to an embodiment of the present disclosure, a non-transitory computer-readable storage medium storing instructions may be proposed. For example, when executed, the instructions may cause a first apparatus to: generate a sidelink (SL) synchronization signal block (SSB); and transmit the SL SSB to a second apparatus. For example, the SL SSB may include a first SL primary synchronization signal (PSS), a second SL PSS, a first SL secondary synchronization signal (SSS), and a second SL SSS, wherein the first SL SSS is generated based on a first m-sequence and a second m-sequence, and wherein the first SL PSS is generated based on a second polynomial different from a first polynomial related to generation of a Uu PSS and a second cyclic shift different from a first cyclic shift related to the generation of the Uu PSS.

Additionally, for example, a first apparatus may generate a first m-sequence. For example, the first apparatus may generate N sidelink (SL) primary synchronization signals (PSSs) by separating the first m-sequence. For example, the first apparatus may generate a second m-sequence based on a polynomial equal to a polynomial related to the generation of the first m-sequence and a second cyclic shift different from a first cyclic shift related to the generation of the first m-sequence. For example, the first apparatus may generate M third m-sequences by separating the second m-sequence. For example, the first apparatus may generate M SL secondary synchronization signals (SSSs) by sequentially performing exclusive-OR operations on the M third m-sequences. For example, the first apparatus may generate an SL SSB. For example, the first apparatus may transmit the SL SSB to a second apparatus. For example, the SL SBB may include the N SL PSSs and the M SL SSSs, the N is an integer of 2 or more, and the M is an integer of 2 or more.

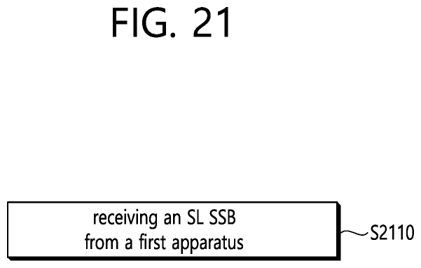

FIG. 21 shows a procedure in which a second apparatus receives an SL SSB, according to an embodiment of the present disclosure. The embodiment of FIG. 21 may be combined with various embodiments of the present disclosure.

Referring to FIG. 21, in step S2110, a second apparatus may receive a sidelink (SL) SSB from a first apparatus. For example, the SL SSB may include a first SL primary synchronization signal (PSS), a second SL PSS, a first SL secondary synchronization signal (SSS), and a second SL SSS, the first SL SSS may be generated based on a first m-sequence and a second m-sequence, and the first SL PSS may be generated based on a second polynomial different from a first polynomial related to generation of a Uu PSS and a second cyclic shift different from a first cyclic shift related to the generation of the Uu PSS.

For example, the first SL PSS may be generated based on a polynomial equal to a polynomial related to generation of the second m-sequence and a second initial value different from a first initial value related to the generation of the second m-sequence.

The above-described embodiment may be applied to various apparatuses to be described below. For example, a processor 202 of a second apparatus 200 may control a transceiver 206 to receive a sidelink (SL) synchronization signal block (SSB) from a first apparatus 100.

According to an embodiment of the present disclosure, a second apparatus for performing wireless communication may be proposed. For example, the second apparatus may comprise: one or more memories storing instructions; one or more transceivers; and one or more processors connected to the one or more memories and the one or more transceivers. For example, the one or more processors may execute the instructions to: receive a sidelink (SL) synchronization signal block (SSB) from a first apparatus. For example, the SL SSB may include a first SL primary synchronization signal (PSS), a second SL PSS, a first SL secondary synchronization signal (SSS), and a second SL SSS, wherein the first SL SSS may be generated based on a first m-sequence and a second m-sequence, and wherein the first SL PSS may be generated based on a second polynomial different from a first polynomial related to generation of a Uu PSS and a second cyclic shift different from a first cyclic shift related to the generation of the Uu PSS.

For example, the first SL PSS is generated based on a polynomial equal to a polynomial related to generation of the second m-sequence and a second initial value different from a first initial value related to the generation of the second m-sequence.

Hereinafter, device(s) to which various embodiments of the present disclosure can be applied will be described.

The various descriptions, functions, procedures, proposals, methods, and/or operational flowcharts of the present disclosure described in this document may be applied to, without being limited to, a variety of fields requiring wireless communication/connection (e.g., 5G) between devices.

Hereinafter, a description will be given in more detail with reference to the drawings. In the following drawings/description, the same reference symbols may denote the same or corresponding hardware blocks, software blocks, or functional blocks unless described otherwise.

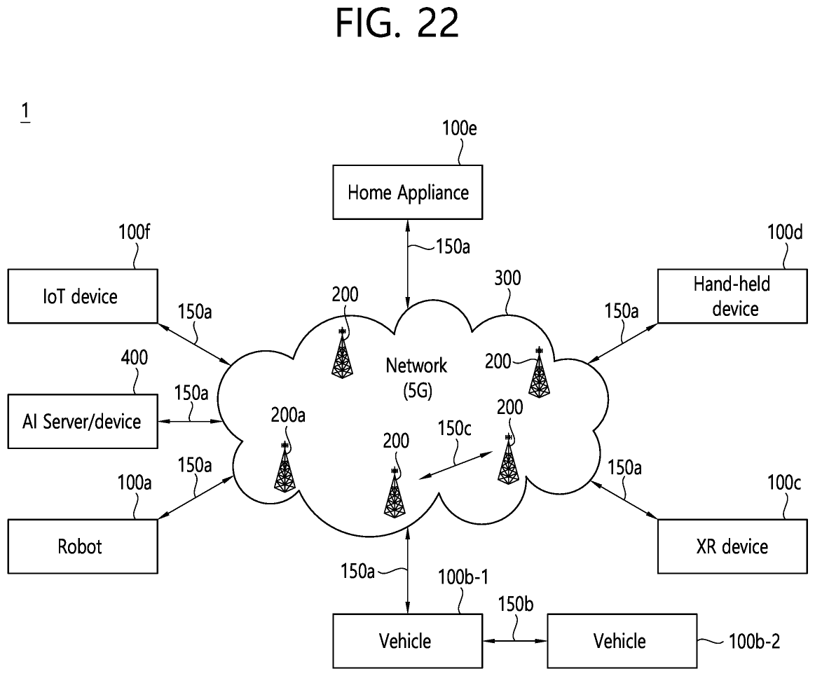

FIG. 22 shows a communication system 1, in accordance with an embodiment of the present disclosure.

Referring to FIG. 22, a communication system 1 to which various embodiments of the present disclosure are applied includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

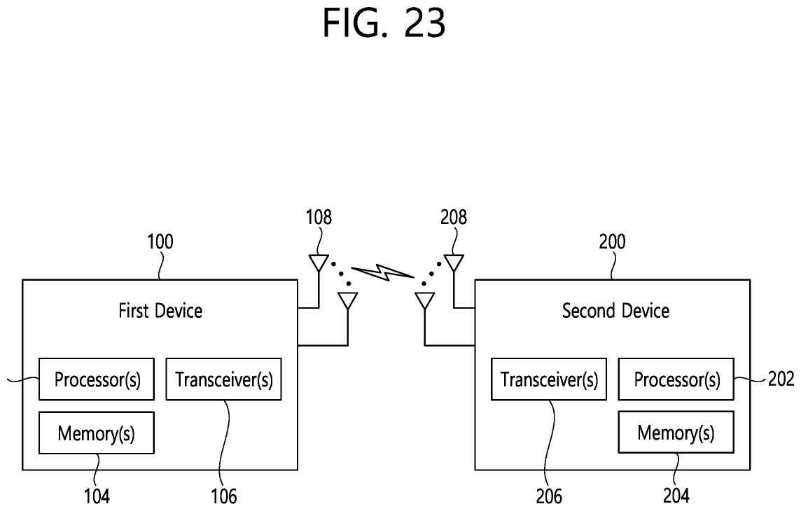

FIG. 23 shows wireless devices, in accordance with an embodiment of the present disclosure.

Referring to FIG. 23, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 22.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

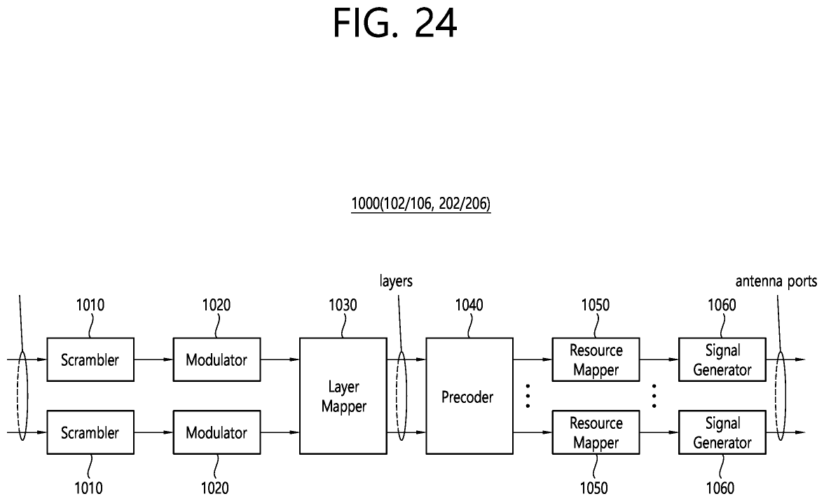

FIG. 24 shows a signal process circuit for a transmission signal, in accordance with an embodiment of the present disclosure.

Referring to FIG. 24, a signal processing circuit 1000 may include scramblers 1010, modulators 1020, a layer mapper 1030, a precoder 1040, resource mappers 1050, and signal generators 1060. An operation/function of FIG. 24 may be performed, without being limited to, the processors 102 and 202 and/or the transceivers 106 and 206 of FIG. 23. Hardware elements of FIG. 24 may be implemented by the processors 102 and 202 and/or the transceivers 106 and 206 of FIG. 23. For example, blocks 1010 to 1060 may be implemented by the processors 102 and 202 of FIG. 23. Alternatively, the blocks 1010 to 1050 may be implemented by the processors 102 and 202 of FIG. 23 and the block 1060 may be implemented by the transceivers 106 and 206 of FIG. 23.

Codewords may be converted into radio signals via the signal processing circuit 1000 of FIG. 24. Herein, the codewords are encoded bit sequences of information blocks. The information blocks may include transport blocks (e.g., a UL-SCH transport block, a DL-SCH transport block). The radio signals may be transmitted through various physical channels (e.g., a PUSCH and a PDSCH).

Specifically, the codewords may be converted into scrambled bit sequences by the scramblers 1010. Scramble sequences used for scrambling may be generated based on an initialization value, and the initialization value may include ID information of a wireless device. The scrambled bit sequences may be modulated to modulation symbol sequences by the modulators 1020. A modulation scheme may include pi/2-Binary Phase Shift Keying (pi/2-BPSK), m-Phase Shift Keying (m-PSK), and m-Quadrature Amplitude Modulation (m-QAM). Complex modulation symbol sequences may be mapped to one or more transport layers by the layer mapper 1030. Modulation symbols of each transport layer may be mapped (precoded) to corresponding antenna port(s) by the precoder 1040. Outputs z of the precoder 1040 may be obtained by multiplying outputs y of the layer mapper 1030 by an N*M precoding matrix W. Herein, N is the number of antenna ports and M is the number of transport layers. The precoder 1040 may perform precoding after performing transform precoding (e.g., DFT) for complex modulation symbols. Alternatively, the precoder 1040 may perform precoding without performing transform precoding.

The resource mappers 1050 may map modulation symbols of each antenna port to time-frequency resources. The time-frequency resources may include a plurality of symbols (e.g., a CP-OFDMA symbols and DFT-s-OFDMA symbols) in the time domain and a plurality of subcarriers in the frequency domain. The signal generators 1060 may generate radio signals from the mapped modulation symbols and the generated radio signals may be transmitted to other devices through each antenna. For this purpose, the signal generators 1060 may include Inverse Fast Fourier Transform (IFFT) modules, Cyclic Prefix (CP) inserters, Digital-to-Analog Converters (DACs), and frequency up-converters.

Signal processing procedures for a signal received in the wireless device may be configured in a reverse manner of the signal processing procedures 1010 to 1060 of FIG. 24. For example, the wireless devices (e.g., 100 and 200 of FIG. 23) may receive radio signals from the exterior through the antenna ports/transceivers. The received radio signals may be converted into baseband signals through signal restorers. To this end, the signal restorers may include frequency downlink converters, Analog-to-Digital Converters (ADCs), CP remover, and Fast Fourier Transform (FFT) modules. Next, the baseband signals may be restored to codewords through a resource demapping procedure, a postcoding procedure, a demodulation processor, and a descrambling procedure. The codewords may be restored to original information blocks through decoding. Therefore, a signal processing circuit (not illustrated) for a reception signal may include signal restorers, resource demappers, a postcoder, demodulators, descramblers, and decoders.

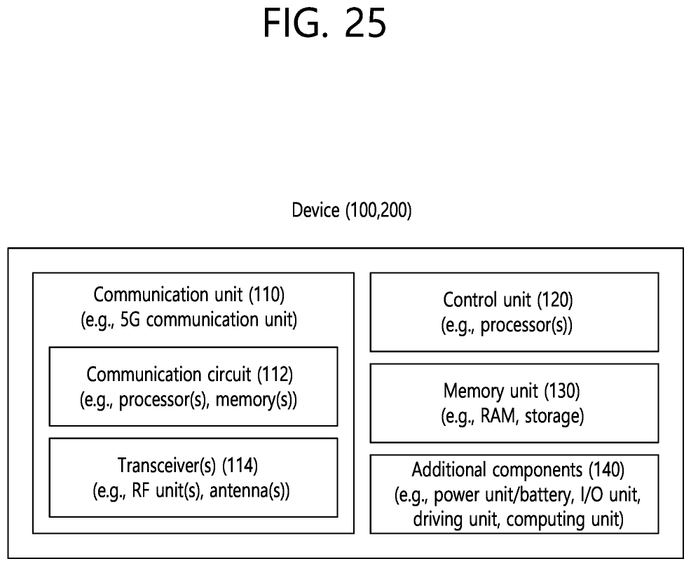

FIG. 25 shows another example of a wireless device, in accordance with an embodiment of the present disclosure. The wireless device may be implemented in various forms according to a use-case/service (refer to FIG. 22).

Referring to FIG. 25, wireless devices 100 and 200 may correspond to the wireless devices 100 and 200 of FIG. 23 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 23. For example, the transceiver(s) 114 may include the one or more transceivers 106 and 206 and/or the one or more antennas 108 and 208 of FIG. 23. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 22), the vehicles (100b-1 and 100b-2 of FIG. 22), the XR device (100c of FIG. 22), the hand-held device (100d of FIG. 22), the home appliance (100e of FIG. 22), the IoT device (100f of FIG. 22), a digital broadcast terminal, a hologram device, a public safety device, an MTC device, a medicine device, a fintech device (or a finance device), a security device, a climate/environment device, the AI server/device (400 of FIG. 22), the BSs (200 of FIG. 22), a network node, etc. The wireless device may be used in a mobile or fixed place according to a use-example/service.

In FIG. 25, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

Hereinafter, an example of implementing FIG. 25 will be described in detail with reference to the drawings.

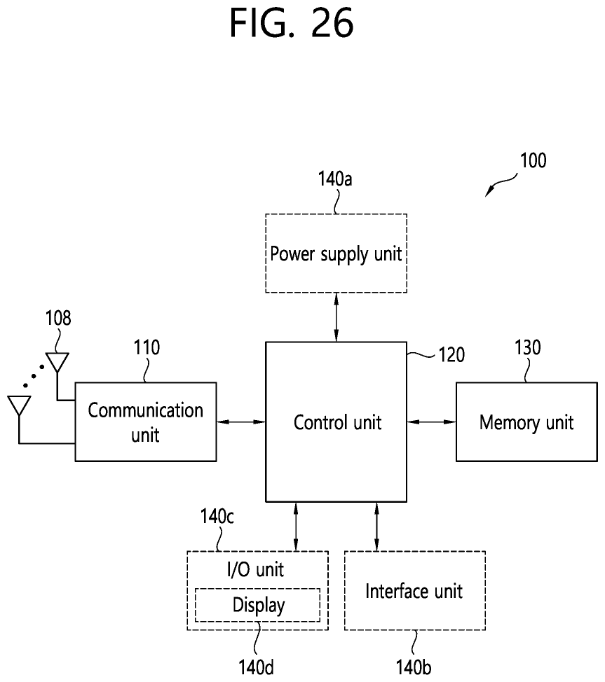

FIG. 26 shows a hand-held device, in accordance with an embodiment of the present disclosure. The hand-held device may include a smartphone, a smartpad, a wearable device (e.g., a smartwatch or a smartglasses), or a portable computer (e.g., a notebook). The hand-held device may be referred to as a mobile station (MS), a user terminal (UT), a Mobile Subscriber Station (MSS), a Subscriber Station (SS), an Advanced Mobile Station (AMS), or a Wireless Terminal (WT).

Referring to FIG. 26, a hand-held device 100 may include an antenna unit 108, a communication unit 110, a control unit 120, a memory unit 130, a power supply unit 140a, an interface unit 140b, and an I/O unit 140c. The antenna unit 108 may be configured as a part of the communication unit 110. Blocks 110 to 130/140a to 140c correspond to the blocks 110 to 130/140 of FIG. 25, respectively.

The communication unit 110 may transmit and receive signals (e.g., data and control signals) to and from other wireless devices or BSs. The control unit 120 may perform various operations by controlling constituent elements of the hand-held device 100. The control unit 120 may include an Application Processor (AP). The memory unit 130 may store data/parameters/programs/code/commands needed to drive the hand-held device 100. The memory unit 130 may store input/output data/information. The power supply unit 140a may supply power to the hand-held device 100 and include a wired/wireless charging circuit, a battery, etc. The interface unit 140b may support connection of the hand-held device 100 to other external devices. The interface unit 140b may include various ports (e.g., an audio I/O port and a video I/O port) for connection with external devices. The I/O unit 140c may input or output video information/signals, audio information/signals, data, and/or information input by a user. The I/O unit 140c may include a camera, a microphone, a user input unit, a display unit 140d, a speaker, and/or a haptic module.

As an example, in the case of data communication, the I/O unit 140c may acquire information/signals (e.g., touch, text, voice, images, or video) input by a user and the acquired information/signals may be stored in the memory unit 130. The communication unit 110 may convert the information/signals stored in the memory into radio signals and transmit the converted radio signals to other wireless devices directly or to a BS. The communication unit 110 may receive radio signals from other wireless devices or the BS and then restore the received radio signals into original information/signals. The restored information/signals may be stored in the memory unit 130 and may be output as various types (e.g., text, voice, images, video, or haptic) through the I/O unit 140c.

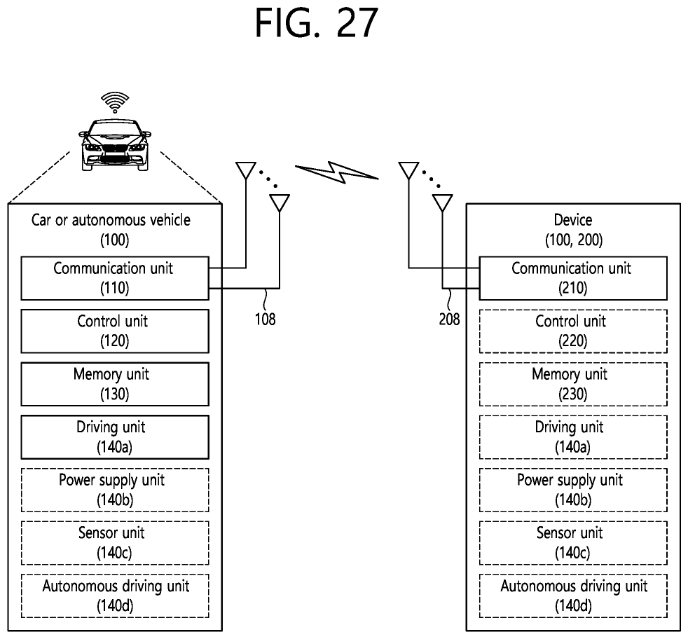

FIG. 27 shows a vehicle or an autonomous vehicle, in accordance with an embodiment of the present disclosure. The vehicle or autonomous vehicle may be implemented by a mobile robot, a car, a train, a manned/unmanned Aerial Vehicle (AV), a ship, etc.

Referring to FIG. 27, a vehicle or autonomous vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 25, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous vehicle 100. The control unit 120 may include an Electronic Control Unit (ECU). The driving unit 140a may cause the vehicle or the autonomous vehicle 100 to drive on a road. The driving unit 140a may include an engine, a motor, a powertrain, a wheel, a brake, a steering device, etc. The power supply unit 140b may supply power to the vehicle or the autonomous vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous vehicles and provide the predicted traffic information data to the vehicles or the autonomous vehicles.

Claims in the present description can be combined in a various way. For instance, technical features in method claims of the present description can be combined to be implemented or performed in an apparatus, and technical features in apparatus claims can be combined to be implemented or performed in a method. Further, technical features in method claim(s) and apparatus claim(s) can be combined to be implemented or performed in an apparatus. Further, technical features in method claim(s) and apparatus claim(s) can be combined to be implemented or performed in a method.

1. A method for transmitting a synchronization signal block (SSB) by a first apparatus, the method comprising:
generating a sidelink (SL) SSB; and
transmitting the SL SSB to a second apparatus,
wherein the SL SSB includes a first SL primary synchronization signal (PSS), a second SL PSS, a first SL secondary synchronization signal (SSS), and a second SL SSS,
wherein the first SL SSS is generated based on a first m-sequence and a second m-sequence, and
wherein the first SL PSS is generated based on a second polynomial different from a first polynomial related to generation of a Uu PSS and a second cyclic shift different from a first cyclic shift related to the generation of the Uu PSS.

2. The method of claim 1, wherein the first SL PSS is generated based on a polynomial and an initial value related to generation of the second m-sequence.

3. The method of claim 1, wherein the first SL PSS is generated based on a polynomial equal to a polynomial related to generation of the second m-sequence and a second initial value different from a first initial value related to the generation of the second m-sequence.

4. The method of claim 1, wherein the first SL PSS is generated based on a polynomial, an initial value, and a cyclic shift related to generation of the second m-sequence.

5. The method of claim 4, wherein the first SL PSS is generated based on a polynomial equal to the polynomial related to the generation of the second m-sequence, an initial value equal to the initial value related to the generation of the second m-sequence, and a fourth cyclic shift different from a third cyclic shift related to the generation of the second m-sequence.

6. The method of claim 5, wherein the second SL PSS is generated based on a polynomial, an initial value, and a cyclic shift related to generation of the first m-sequence.

7. The method of claim 6, wherein the second SL PSS is generated based on a polynomial equal to the polynomial related to the generation of the first m-sequence, an initial value equal to the initial value related to the generation of the first m-sequence, and a sixth cyclic shift different from a fifth cyclic shift related to the generation of the first m-sequence.

8. The method of claim 5, wherein the second SL PSS is generated based on a polynomial, an initial value, and a cyclic shift related to generation of a Uu PSS.

9. The method of claim 8, wherein the second SL PSS is generated based on a polynomial equal to the polynomial related to the generation of the Uu PSS, an initial value equal to the initial value related to the generation of the Uu PSS, and a fifth cyclic shift different from the first cyclic shift related to the generation of the Uu PSS.

10. The method of claim 5, wherein the second SL PSS is equal to the first SL PSS.

11. The method of claim 1, wherein the first SL PSS is generated based on a polynomial and an initial value related to generation of a Uu SSS.

12. The method of claim 11, wherein the first SL PSS is generated based on a polynomial equal to the polynomial related to the generation of the Uu SSS and a second initial value different from a first initial value related to the generation of the Uu SSS.

13. A first apparatus for performing wireless communication, the first apparatus comprising:
one or more memories storing instructions;
one or more transceivers; and
one or more processors connected to the one or more memories and the one or more transceivers, wherein the one or more processors execute the instructions to:
generate a sidelink (SL) synchronization signal block (SSB); and
transmit the SL SSB to a second apparatus,
wherein the SL SSB includes a first SL primary synchronization signal (PSS), a second SL PSS, a first SL secondary synchronization signal (SSS), and a second SL SSS,
wherein the first SL SSS is generated based on a first m-sequence and a second m-sequence, and
wherein the first SL PSS is generated based on a second polynomial different from a first polynomial related to generation of a Uu PSS and a second cyclic shift different from a first cyclic shift related to the generation of the Uu PSS.

14. An apparatus configured to control a first user equipment (UE), the apparatus comprising:
one or more processors; and
one or more memories operably connectable to the one or more processors and storing instructions, wherein the one or more processors execute the instructions to:
generate a sidelink (SL) synchronization signal block (SSB); and
transmit the SL SSB to a second UE,
wherein the SL SSB includes a first SL primary synchronization signal (PSS), a second SL PSS, a first SL secondary synchronization signal (SSS), and a second SL SSS,
wherein the first SL SSS is generated based on a first m-sequence and a second m-sequence, and
wherein the first SL PSS is generated based on a second polynomial different from a first polynomial related to generation of a Uu PSS and a second cyclic shift different from a first cyclic shift related to the generation of the Uu PSS.

15-20. (canceled)
